(19) United States
(12) Patent Application Publication
(10) Pub. No.: US 2024/0415090 A1
(43) Pub. Date: Dec. 19, 2024

(54) SYSTEMS FOR IN-CAGE ANIMAL BEHAVIOR SENSING

(71) Applicant: VANDERBILT UNIVERSITY, Nashville, TN (US)

(72) Inventors: Marie A. Doyle, Nashville, TN (US); Nicholas Petersen, Nashville, TN (US); Danny G. Winder, Nashville, TN (US)

(21) Appl. No.: 18/743,323

(22) Filed: Jun. 14, 2024

Related U.S. Application Data
(60) Provisional application No. 63/521,169, filed on Jun. 15, 2023.

(51) Int. Cl. A01K 1/03; A01K 7/06; A01K 29/00; G01D 5/24

(52) U.S. Cl. CPC A01K 1/031; A01K 7/06; A01K 29/005; G01D 5/24

(57) ABSTRACT

Disclosed are various approaches for providing an in-cage system for sensing animal behaviors. In one example, a lick detection device is provided. The lick detection device includes a frame having at least one bottle orifice and a hanger. The lick detection device further includes a sipper clip connected to the frame by a leg. Finally, the lick detection device includes a conductive strip on an interior surface of the sipper clip.

### CROSS REFERENCE TO RELATED APPLICATIONS

This application claims priority to, and the benefit of, co-pending U.S. provisional application entitled “Systems For In-Cage Animal Behavior Sensing” having Ser. No. 63/521,169, filed Jun. 15, 2023, which is hereby incorporated by reference in its entirety.

### STATEMENT REGARDING FEDERALLY SPONSORED RESEARCH OR DEVELOPMENT

This invention was made with Government support under contracts AA019455, AA029592, and AA029599 awarded by the National Institutes of Health. The Government has certain rights in the invention.

### BACKGROUND

Investigation of rodent drinking behavior has provided insight into drivers of thirst, circadian rhythms, anhedonia, and drug and ethanol consumption. Traditional methods of recording fluid intake involve weighing bottles, which is cumbersome and lacks temporal resolution. Several open-source devices have been designed to improve drink monitoring, particularly for two-bottle choice tasks. However, recent designs are limited by the use of infrared photobeam sensors and incompatibility with prolonged undisturbed use in ventilated home cages. Beam-break sensors lack accuracy for bout microstructure analysis and are prone to damage from rodents.

### BRIEF DESCRIPTION OF THE DRAWINGS

Further aspects of the present disclosure will be more readily appreciated upon review of the detailed description of its various embodiments, described below, when taken in conjunction with the accompanying drawings.

FIGS. 1A-1F show an example LIQ HD design and validation thereof in accordance with embodiments of the present disclosure. FIG. 1A, 3D rendering of LIQ HD disassembled components, including 3D-printed parts, rubber stoppers with sippers, and conductive copper foil tape. FIG. 1B, LIQ HD electronic parts and wiring diagram. FIG. 1C, Correlation between total lick number and change in bottle weight for each recording period. FIG. 1D, Correlation between total lick duration and change in bottle weight for each recording period. FIG. 1E, Correlation between total lick number and lick duration for each recording period. In correlation graphs, solid lines represent a fitted simple linear regression model, and dashed lines denote 95% confidence intervals. FIG. 1F, Lick number and estimated water consumption throughout an undisturbed 7-day recording period with access to two water bottles. Data from both water bottles are combined to show the total intake per cage. The shaded areas between ZT times 12 and 0 signify the dark/active phase. The solid line represents the mean lick number and estimated intake in 1-hour bins, and the shaded area represents ±SEM (n=16 cages). The raster plot displays licks detected in 1-minute bins for each cage. FIGS. 1G-1J illustrate the infrared photobeam-based two-bottle choice device design, wiring diagram, and validation. Infrared photobeam-based two-bottle choice device design and validation. FIG. 1G, Electronic parts and wiring diagram for the beam-break system. FIG. 1H, 3D rendering of beam-break device, including 3D-printed components, rubber stoppers and sippers, and photobeam sensors (red). FIG. 1I, Correlation between total bout number and change in bottle weight for each recording period. FIG. 1J, Correlation between total bout duration and change in bottle weight for each recording period. Solid lines represent fitted simple linear regression models, and dashed lines denote 95% confidence intervals.

FIGS. 2A-2K illustrate studies of utilizing LIQ HD to investigate changes in drink preference and light/dark cycle drinking patterns in sucrose and quinine two-bottle choice paradigms. FIG. 2A, Correlation between percent preference calculated with lick number and percent preference calculated with change in bottle weight for each recording period. FIG. 2B, Correlation between percent preference calculated with lick duration and percent preference calculated with change in bottle weight for each recording period. Solid lines represent fitted simple linear regression models, and dashed lines denote 95% confidence intervals. FIG. 2C, Preference over time in 1-hour bins for the sucrose and quinine two-bottle choice dose-response paradigm. The solid line represents smoothed mean (sliding window length of 6), and the shaded area signifies ±SEM (n=8 cages for each group). Vertical dashed lines indicate when bottles swapped sides and when indicated, a change in experimental solution in one bottle. FIGS. 2D-2I, Lick number over time in 1-hour bins for recording periods for the two-bottle choice sucrose and quinine dose response paradigms. The shaded areas between ZT times 12 and 0 signify the dark/active phase. FIG. 2J, Percentage of total licks that occur during the dark and light phases for recording periods of the sucrose dose-response paradigm (repeated measures two-way ANOVA, with the Geisser-Greenhouse correction and Tukey multiple comparisons test). During access to 10% sucrose, the percentage of licks that occurred during the dark phase was significantly decreased, and the percentage of licks that occurred during the light phase was significantly increased when compared to 0.5% and 1% sucrose availability. FIG. 2K, Percentage of total licks during the dark and light phases for the quinine dose-response paradigm (repeated measures two-way ANOVA, with the Geisser-Greenhouse correction and Tukey multiple comparisons test). Shaded areas and error bars represent ±SEM. ***p<0.0001.

FIGS. 3A-3D provide histograms of average baseline bout microstructure measurements from 1-hour bins during 1-week access to two water bottles (N=16 mice, n=32 bottles) in accordance with embodiments of the present disclosure. Histogram displaying bout duration (FIG. 3A), bout size (FIG. 3B), lick frequency (FIG. 3C), and estimated inter-lick interval (FIG. 3D). Black and gray dashed lines represent the median and mean, respectively.

FIGS. 4A-4L show validation of LIQ HD bout detection and bout microstructure in an ethanol two-bottle choice paradigm in accordance with embodiments of the present disclosure. FIG. 4A, Correlation between total bout number and change in bottle weight for each recording period. FIG. 4B, Correlation between total bout duration and change in bottle weight for each recording period. FIG. 4C, Correlation between percent preference calculated with bout number and percent preference calculated with change in bottle weight for each recording period. FIG. 4D, Correlation between percent preference calculated with bout duration and percent preference calculated with change in bottle weight for each recording period. Solid lines represent a fitted simple linear regression model, and dashed lines denote 95% confidence intervals. FIG. 4E, Preference over time in 1-hour bins for the ethanol two-bottle choice paradigm. The solid line represents smoothed mean (sliding window length of 6), and shaded area signifies ±SEM (n=8 cages). Vertical dashed lines indicate when bottles swapped sides and when indicated, a change of experimental solution in one bottle. FIG. 4F, Average preference for experimental bottle during ethanol two-bottle choice paradigm (repeated measures one-way ANOVA, with the Geisser-Greenhouse correction and Dunnett's multiple comparisons test). Mice show significantly increased preference compared to baseline for 7% and 10% ethanol. Bout duration (FIG. 4G), bout size (FIG. 4I, lick frequency, and estimated inter-lick interval (FIG. 4K) over time in 24-hour bins for water and ethanol bottles. Average bout duration (FIG. 4H), bout size (FIG. 4J), lick frequency, and estimated inter-lick interval (FIG. 4L) during access to two water bottles and access to water with increasing concentrations of ethanol (repeated measures two-way ANOVA, with the Geisser-Greenhouse correction and Dunnett's multiple comparisons test). At the ethanol bottle, mice display a significant decrease in bout duration (FIG. 4G), bout size (FIG. 4I), and inter-lick interval (FIG. 4L) with a significant increase in lick frequency during access to increasing concentrations of ethanol. At the water bottle, mice display a significant increase in lick frequency only during access to 3% ethanol, a significant decrease in bout duration during access to 3% and 10% ethanol (FIG. 4H), and a significant decrease in bout size only during access to 10% ethanol (FIG. 4J). Shaded areas and error bars represent ±SEM. *p<0.05, **p<0.01, ***P<0.001, ****p<0.0001.

FIG. 5 shows an illustration of the device, where left and right denote the user view from outside the cage in accordance with embodiments of the present disclosure.

FIG. 6 shows an illustration of a frame without the bottles inserted in accordance with embodiments of the present disclosure.

FIG. 7 shows an illustration of the top portion in accordance with embodiments of the present disclosure.

FIG. 8 shows an illustration of the legs in accordance with embodiments of the present disclosure.

FIG. 9 shows an illustration of the sipper clip in accordance with embodiments of the present disclosure.

FIG. 10 shows an illustration of an example of the bottles in accordance with embodiments of the present disclosure.

FIG. 11 shows an illustration of a frame without the bottles inserted in accordance with various embodiments of the present disclosure.

FIG. 12 shows an illustration of the bottles in accordance with various embodiments of the present disclosure.

FIG. 13 shows an illustration of the bottom of the device in accordance with various embodiments of the present disclosure.

FIG. 14 shows an illustration of the device inserted in accordance with various embodiments of the present disclosure.

FIG. 15 shows an illustration of the top of the device inserted in accordance with various embodiments of the present disclosure.

FIG. 16 shows an illustration of sipper clips in accordance with various embodiments of the present disclosure.

The drawings illustrate only example embodiments and are therefore not to be considered limiting of the scope described herein, as other equally effective embodiments are within the scope and spirit of this disclosure. The elements and features shown in the drawings are not necessarily drawn to scale, emphasis instead being placed upon clearly illustrating the principles of the embodiments. Additionally, certain dimensions may be exaggerated to help visually convey certain principles. In the drawings, similar reference numerals between figures designate like or corresponding, but not necessarily the same, elements.

### DETAILED DESCRIPTION

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of biophysics, animal behavior, neurology, engineering, and the like, which are within the skill of the art.

The following examples are put forth so as to provide those of ordinary skill in the art with a complete disclosure and description of how to perform the methods and use the methods and devices disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise.

As used herein, the following terms have the meanings ascribed to them unless specified otherwise. In this disclosure, “consisting essentially of” or “consists essentially” or the like, when applied to methods and compositions encompassed by the present disclosure refers to compositions like those disclosed herein, but which may contain additional structural groups, composition components or method steps (or analogs or derivatives thereof as discussed above). Such additional structural groups, composition components or method steps, etc., however, do not materially affect the basic and novel characteristic(s) of the compositions or methods, compared to those of the corresponding compositions or methods disclosed herein. “Consisting essentially of” or “consists essentially” or the like, when applied to methods and compositions encompassed by the present disclosure have the meaning ascribed in U.S. Patent law and the term is open-ended, allowing for the presence of more than that which is recited so long as basic or novel characteristics of that which is recited is not changed by the presence of more than that which is recited, but excludes prior art embodiments.

### GENERAL DISCUSSION

In accordance with the purpose(s) of the present disclosure, as embodied and broadly described herein, embodiments of the present disclosure, in some aspects, relate to devices and systems for investigating animal behavior, including lick detection and bottle choice.

In general, embodiments of the present disclosure provide for a device for animal lick detection, and systems for animal lick detection. Animals, as used herein, generally refer to rats or mice but the system can be used in studies of any animal feeding from a feeder bottle. Where a specific animal is named, this is intended to be a non-limiting example.

Using the system, a user can collect data regarding animal behavior relating to drinking or feeding, including the number of licks, lick frequency, inter-lick interval, and volume of liquid. Where more than one bottle is provided per animal, behavior related to bottle choice can also be collected.

The present disclosure includes a device including a frame comprising at least one bottle orifice and a hanger; a sipper clip connected to the frame by a leg; and a conductive strip on an interior surface of the sipper clip. Advantageously, the system allows for recording of liquid feeding or drinking behavior in an animal's home cage, minimizing the effects of stress in an unfamiliar environment. No cage modifications are needed, normal bedding can be used, and there is no need for a conductive plate in the cage.

In some examples, the device includes a housing disposed beneath the at least one bottle orifice. The housing can encompass one or more bottle orifices included in the frame. In some examples, the housing has a tunnel leading to each bottle orifice, wherein the tunnel is configured to receive at least the head and neck of an animal subject. The housing can include at least one sensor directed toward the at least one bottle orifice. In some examples, the housing can include a sensor in each tunnel which leads to a bottle orifice. The sensor can be representative of a radiofrequency identification (RFID) sensor, a Bluetooth sensor, near field communication (NFC) sensor, a code scanning sensor (e.g., barcode scanner, QR code scanner, etc.), or other similar sensor device. The sensor can be configured to detect an identifier on an animal subject. In at least one example, an RFID sensor within the housing can scan an RFID implant or collar found on the animal subject.

In various embodiments, the device includes at least one bottle having a sipper. When bottles are inserted in the bottle orifice, the sipper inserts into the sipper clip such that the sipper is in contact with the conductive tape. In a specific embodiment, the sipper is stainless steel. In other embodiments, other conductive materials can be used, including but not limited to materials including silver, copper, gold, aluminum, zinc, nickel, brass, bronze, iron, platinum, steel, lead, and stainless steel.

In a particular embodiment, the system includes two bottles for such as the investigation of bottle choice drinking behavior. However, as can be envisioned by one of ordinary skill in the art, the system can be adapted to include a single or multiple bottles depending on the needs of a particular study.

Bottles, as used herein refer to sipper bottles commonly used in rodent studies. In the present disclosure, custom sipper bottles are used with the system, however the frame could be adapted to receive commercially-available bottles such as 50 mL conical tubes with a rubber stopper and metal sipper. Animals may chew on the toggle spouts, producing false lick counts. Ball spouts having a metal ball could be used, but can dispense liquid without direct contact by the animal and therefore do not provide results that are as accurate as sipper bottles.

In some embodiments, the body of bottles can be screwed to the sipper and are refilled by removing the bottle from the device and unscrewing the sipper.

In a particular embodiment, the bottles can be pyramidally-shaped such that they taper into the sipper. In a particular embodiment for use in a standard one-mouse cage in a ventilation rack, the bottle capacity can be about 25 mL to 300 mL, or about 90 mL. As can be envisioned by one of ordinary skill in the art, the bottle capacity can be changed, as can the dimensions of the design, depending on the intended use. For iterations for use in other species/animals, the size of the bottle would be scaled up to fit the size of the enclosure.

As can be envisioned by one of ordinary skill in the art, the device, excluding the metal sipper can be made from plastics and can be manufactured using 3D printing, injection molding, or other suitable methods.

The hangers one the frame allow for the device to be hung onto the side of the enclosure. In a two-bottle device, the frame can include two hangers separated by a wiring notch.

The sipper clip can be mounted on a leg connected to the frame. The leg can be detachably connected. The leg can have an opening to receive wiring from the conductive strip. This wiring can be fed through the opening in the leg, exiting through the wiring notch.

Embodiments of the present disclosure include a system including a device as above, wherein the system further includes electrical components to collect and analyze data and to control various operations of the system. In various embodiments, the conductive strip is wired to a capacitive sensor and the capacitive sensor is in communication with a microcontroller. A data logger can be in communication with the microcontroller, a user device in communication with the microcontroller, a memory, and a power source.

In some embodiments, the conductive strip is such as copper tape or pyralux.

The system can further include a data logger shield so that the memory can be a removable memory such as an SD card, flash drive, or other removable memory.

In some embodiments, the system can be equipped with WiFi or other wireless capabilities to remotely monitor data collection and save data.

In some embodiments, the capacitive sensor is a multichannel sensor in communication with a plurality of sipper bottles. For example, a capacitive sensor on a 12-channel board can sense 12 bottles (e.g., 6 cages with two bottles each). Multiple boards can be linked to a single microcontroller to scale the number of bottles that can be included in the system. For example, 4 capacitive sensor boards can be connected to a single microcontroller for a 24 device (48 bottle) capacity. In other embodiments, the system can be scaled using sensors with more channels, a more powerful microcontroller, and/or linking multiple microcontrollers.

Advantageously, the system can record temporally precise data (e.g., in one-minute or more frequent intervals) during prolonged undisturbed tasks. The system can simultaneously record data on a large number of ventilated home cages.

In a particular example, a system using four sensor boards can record data from up to 24 devices (e.g., 48 sipper bottles), meaning that data can be collected from 24 animals at once. Similarly, a system using three sensor boards can record data from up to 18 devices (e.g., 36 sipper bottles, 18 devices). The bottles have a large capacity (e.g., about 90 mL), allowing prolonged studies without disturbing the animals.

Because of the sipper clip configuration and use of a capacitance sensor, non-lick contact such as snouts, paws, or fur, is minimized when compared to existing systems.

Advantageously, the system is low-cost and easy to build.

In some embodiments, some or all of the electrical components (e.g., the capacitance sensors, data logger, data logger shield, and microcontroller) can be enclosed in a housing.

In some embodiments, the system can be controlled via touchscreen with an intuitive graphical user interface. In some embodiments, the touchscreen can communicate wirelessly with the microcontroller. In some embodiments, the touchscreen can be wired to the microcontroller. In yet other embodiments, the graphical user interface can be accessed on a device such as a computer, tablet, or mobile phone.

In some embodiments, a sensor can be connected to the system to record other conditions that influence drinking behavior such as ambient temperature, humidity, or animal movement.

A bout, as used herein, refers to bursts of sustained drinking (e.g., multiple licks) by an individual animal, defined as a sequence of at least three licks within 1 second as the start of a bout, and no licks for 3 seconds as the end of a bout. Bout microstructure, as used herein, refers to data related to bout duration, bout size, lick frequency, and inter-lick interval.

### EXAMPLES

Now having described the embodiments of the disclosure, in general, the examples describe some additional embodiments. While embodiments of the present disclosure are described in connection with the example and the corresponding text and figures, there is no intent to limit embodiments of the disclosure to these descriptions. On the contrary, the intent is to cover all alternatives, modifications, and equivalents included within the spirit and scope of embodiments of the present disclosure.

### Example 1

The system, referred to as the LIQ HD (Lick Instance Quantifier Home cage Device) was designed with the goal of utilizing capacitive sensors to increase accuracy and analyze lick microstructure, building a device compatible with ventilated home cages, increasing scale with prolonged undisturbed recordings, and creating a design that is easy to build and use with an intuitive touchscreen graphical user interface.

In some embodiments, the system tracks two-bottle choice licking behavior in up to 18 rodent cages, or 36 single bottles, on a minute-to-minute timescale controlled by a single Arduino microcontroller. The data are logged to a single SD card, allowing for efficient downstream analysis. With sucrose, quinine, and ethanol two-bottle choice tasks, we validated that LIQ HD has superior accuracy compared to photobeam sensors. The system measures preference over time and changes in bout microstructure, with undisturbed recordings lasting up to 7 days. All designs and software are open-source to allow other researchers to build upon the system and adapt LIQ HD to their animal home cages.

### Significance Statement

Two-bottle choice drinking tasks are traditionally performed by periodically weighing bottles, which is cumbersome and lacks temporal resolution. Several open-source tools have been developed to improve drink monitoring in various settings. However, no open-source devices have been designed specifically to investigate temporally precise two-bottle choice drinking behavior and bout microstructure during prolonged undisturbed tasks in mouse ventilated home cages at a large scale. One embodiment of the LIQ HD (Lick Instance Quantifier Home cage Device) is a home-cage compatible system that utilizes capacitive sensors for highly accurate lick detection during two-bottle choice tasks in up to 18 cages driven by a single Arduino microcontroller. The system is low-cost, easy to build, and controlled via touchscreen with an intuitive graphical user interface. The system can be readily expanded by increasing the number of capacitive sensor boards, such as 4 boards to accommodate 48 sippers. By adding a multiplexer, users can connect multiple sensor boards that have the same address. For example, a multiplexer with 8-channels and 8 configurable I2C addresses allows for up 64 I2C devices to communicate with a single microcontroller. Thus, the LIQ HD system could be modified to theoretically support up to 768 sippers, or 384 cages with two bottles.

### INTRODUCTION

Monitoring of fluid intake and drinking behaviors is a powerful toolset in neuroscience research. These data provide insight into maladaptive behaviors observed in a wide range of disorders, such as obesity, substance use, depression, and others. A rich literature describes key brain regions in which populations of neurons are drivers of thirst, anhedonia, circadian rhythms of fluid consumption, and drug and ethanol consumption. Typical examples of such studies utilize standard voluntary two-bottle choice tasks in which animals are provided bottles in the home cage, one containing water and the other an experimental solution. Measures of fluid intake and preference are then calculated from bottle weight measurements manually taken by experimenters.

While two-bottle choice tasks remain the most common method for studying voluntary intake in rodents, performing the task manually is cumbersome, as data are traditionally collected by taking weight measurements throughout a specific time period, usually 1-3 days. Although this technique provides valuable information to researchers, it lacks temporal resolution. Increasing the frequency of bottle weighing increases variability and adds additional stress, as the animals must be disturbed to collect the data. Commercially available systems can track drinking behavior in a more automatized fashion in a home cage environment (Mingrone et al., 2020). These automated home cage monitoring systems are valuable because they generate data from a substantial number of different behavioral and metabolic measurements and drinking behavior. However, they are costly, require trained personnel, limit the number of cages that can be used, and are only available at a limited number of research institutions. Similarly, operant conditioning chambers can be used for assaying motivated behaviors related to fluid intake and tracking fine details associated with these behaviors, including lick microstructures; however, these tasks are not performed in a home cage environment and similarly require additional equipment and specialized training.

Caveats like those described above have inspired groups to develop open-source tools to study rodent drinking behaviors. The technology to detect licks (“lickometer”) or drink events for these devices has generally fallen into three categories: electrical lick sensors, optical lick sensors, and force lick sensors (Ulman et al., 2008; Weijnen, 1998). Early lickometer designs, although accurate, were hindered by a lack of easy-to-use commercially available components (Dole et al., 1983; Mundl and Malmo, 1979) or sub-optimal compatibility with the home cage environment (Schoenbaum et al., 2001). Newer systems typically involve the use of inexpensive, commercially available sensors and components controlled by either a standard computer or microcontrollers, such as an Arduino or Raspberry Pi. Recently, two versions of infrared (IR) photobeam-break sensor based systems have been a common choice for detecting rodent drink events in a home cage environment (Frie and Khokhar, 2019; Godynyuk et al., 2019). The devices generated by these groups have filled many user needs, chiefly generating easy-to-use open-source designs that greatly improved the temporal resolution of drinking data. Godynyuk et al. created a mouse system optimized for use with in vivo recordings, such as fiber photometry; however, this system only has a capacity of 15 mL per bottle, which would require significant investigator work to refill bottles for chronic fluid measurements. Frie et al. built off this first system by adapting it for rat cages and adding a capacitance-sensing eTape to monitor changes in fluid levels within each water bottle. Again, while this design includes an innovative eTape-based measure of fluid levels, it is not compatible with ventilated mouse home cages due to its size. Finally, as the IR sensors are triggered by the animal's snout in addition to its tongue, they detect drinking events rather than individual licks, thus making all IR beam break-based systems incompatible for the analysis of bout microstructure.

The use of electrical- or capacitive-sensing has shown to have superior accuracy in detecting licks (Longley et al., 2017; Melo et al., 2022; Parkison et al., 2012). However, previously developed electrical-sensing devices are not designed to be compatible with a home cage because they require the use of a metal floor plate in a custom-built enclosure (Melo et al., 2022; Raymond et al., 2018). Devices that utilize a capacitive sensor on a chip do not require a metal place, providing greater design flexibility. Capacitive sensors have allowed groups to design systems optimized for detecting licks in combination with recording movement (Parkison et al., 2012) and rat home cage operant devices (Longley et al., 2017). However, current designs using this technology are limited by their incompatibility with ventilated mouse home cages within a typical animal vivarium (Parkison et al., 2012) or have limited scalability (one device per microcontroller) (Longley et al., 2017), which is a common issue across most devices (Godynyuk et al., 2019; Raymond et al., 2018). Thus, our goal was to design a device that utilizes capacitive sensing on a chip for accuracy and consistency, is compatible with a proper undisturbed mouse home cage environment and is scalable to record from multiple cages from a single microcontroller. In addition, we sought for the device to be used undisturbed for more extended periods of time (hold more fluid volume), have in-cage sensing components that are resistant to rodent destruction, and be intuitive and easy to build and use.

The present system, LIQ HD (Lick Instance Quantifier Home cage Device) is an affordable, intuitive, and easy-to-build device that utilizes capacitive sensor technology to track two-bottle choice drinking behavior in up to 18 rodent home cages, or 36 single bottles, on a minute-to-minute timescale running off a single Arduino microcontroller. The system is built with 3D-printed parts and affordable commercially available electronics. Unlike most currently available open-source systems, our device is designed to be implemented directly in the animal's home cage while on ventilated animal facility racks without any cage modification or requiring special housing conditions. The data for all cages are logged to a single SD card, allowing for efficient downstream analysis. Additionally, the system features a touchscreen controller with an intuitive graphical user interface to prevent the need for any code modification between experiments. Licks captured with LIQ HD strongly correlate with the volume consumed and has been tested in our hands with continued use over several months, with undisturbed runs for up to 7 days. Within the minute-by-minute data, in addition to lick number and lick duration, researchers can track drink preference as well as changes to the animals' bout microstructure (bout duration, bout size, lick frequency, inter-lick interval) over time. It is our goal that LIQ HD will provide researchers with the tools necessary to gather fine-tuned drinking behavior data and streamline two-bottle choice paradigms, particularly those involving long-term home cage monitoring, such as ethanol two-bottle choice.

### Materials and Methods

### LIQ HD Build Instructions

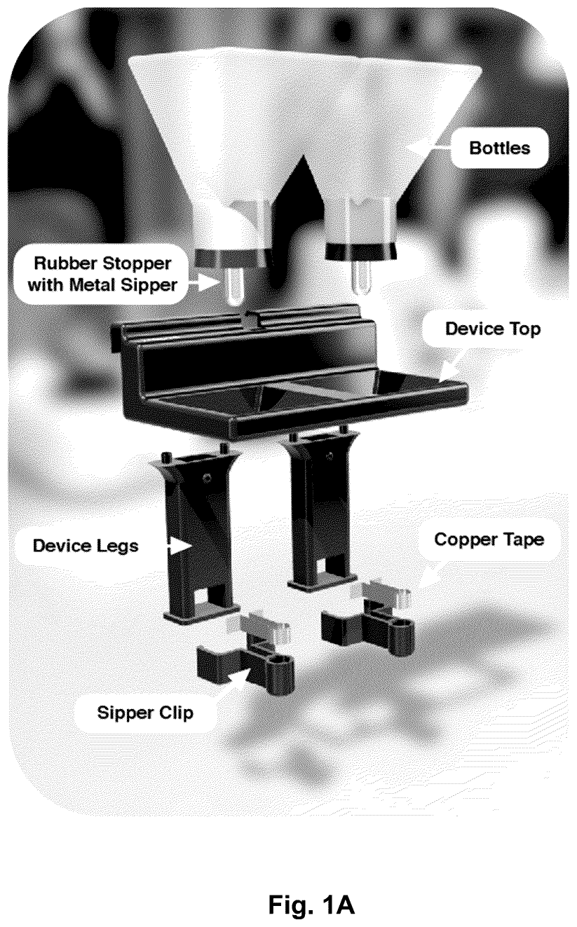

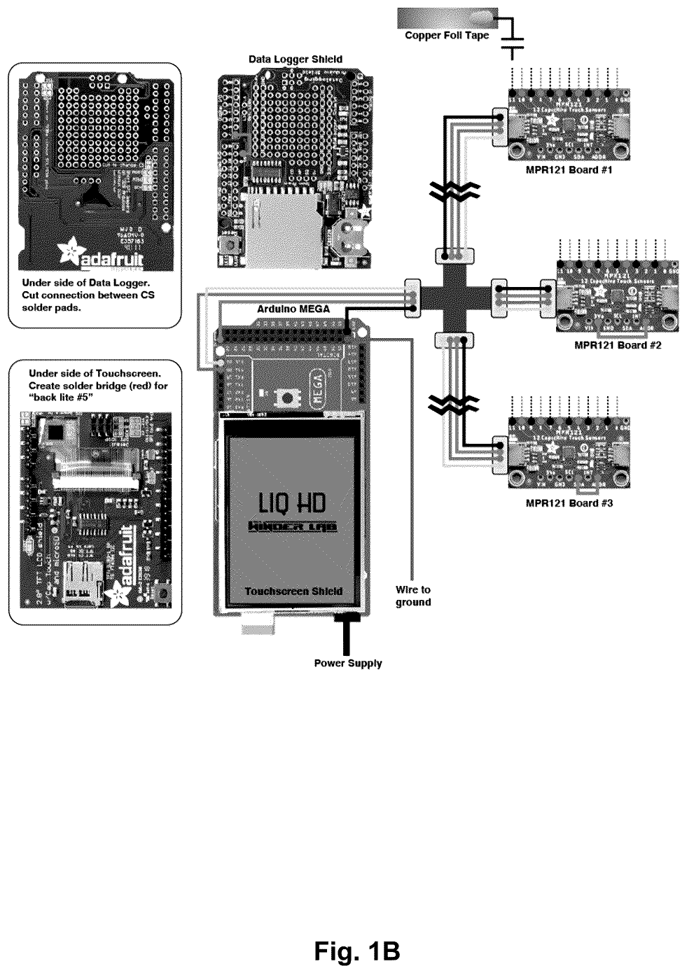

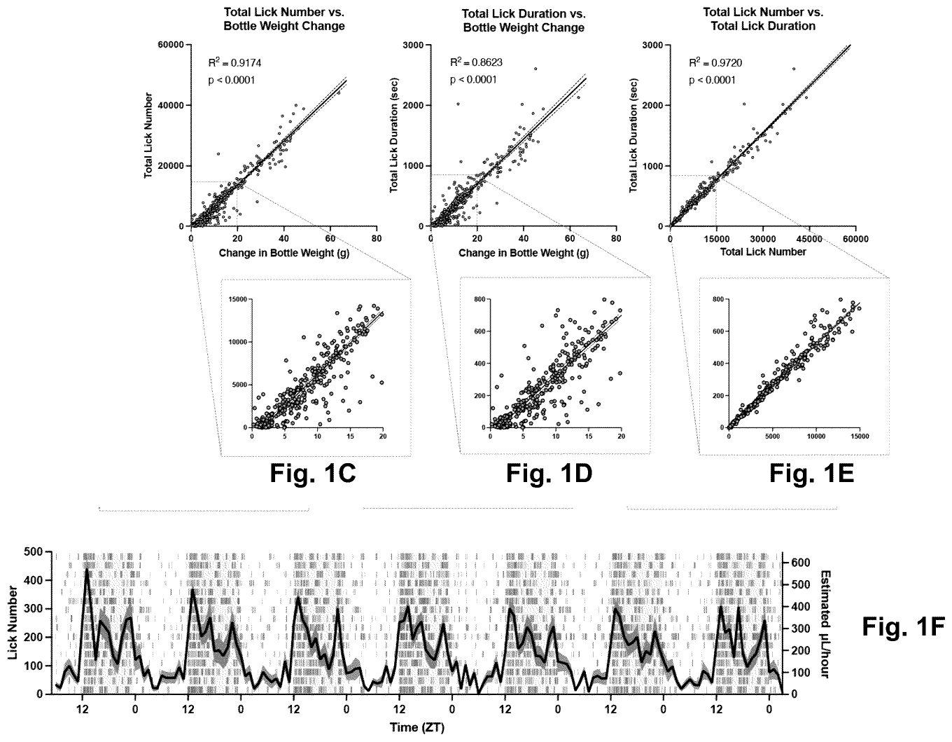

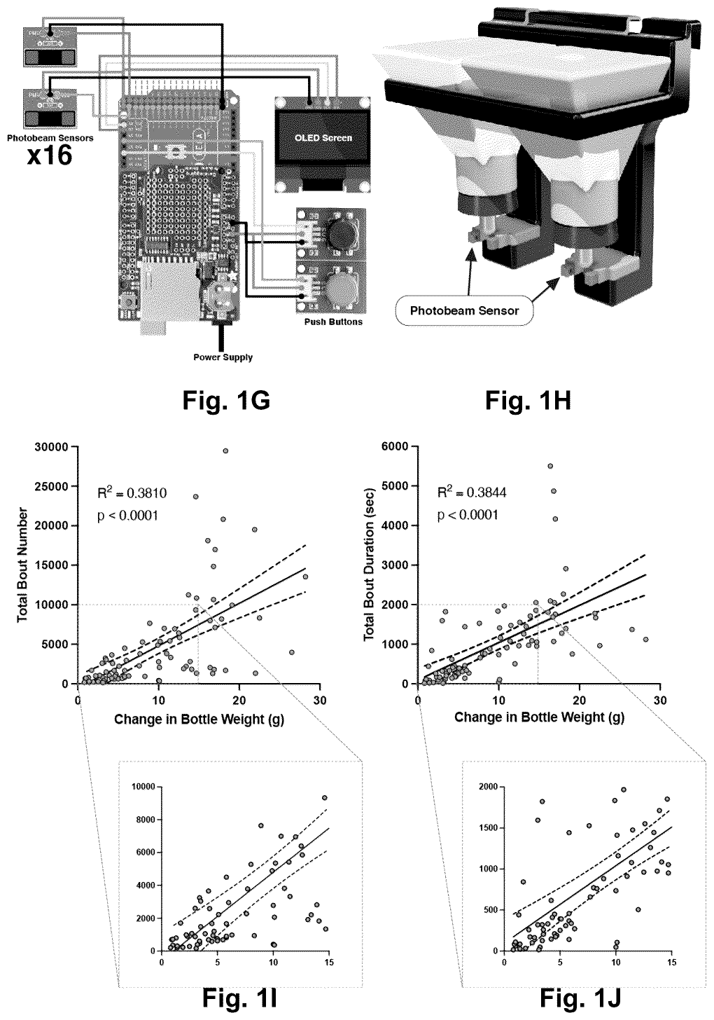

In an embodiment, LIQ HD is built from commercially available electronic components combined with 3D-printed parts. The system controls 3 separate 12-channel MPR121 capacitive sensor breakout boards (Adafruit) for a total of 18 individual devices (with 2 sippers each) and runs off a single Arduino Mega microcontroller (FIGS. 1A, 1B). This capacitance-based sensor determines touch events by calculating a change in capacitance, or the ability of an object or substance to store an electric charge. This method does not require for a circuit to be completed for touch detection, thus there is no need for a conductive plate in the animal cage, and normal bedding can be utilized. Each metal sipper is in contact with conductive copper foil tape that is wired to an MPR121 capacitance sensor breakout board. With only the very tip of the sipper exposed, the device can sense individual licks without interference from other parts of the animal. While we have not done so, the Arduino code can be modified to support up to 4 separate MPR121 boards for a total of 24 devices (48 sippers). Date and time are kept with the Adafruit Data Logger Shield, which keeps time even if the device is unplugged or reset. The Data Logger Shield also writes the data to a single file on an SD card for efficient downstream analysis. Finally, a 2.8″ Adafruit Touchscreen Shield is used to display an easy-to-use graphical user interface. This allows for the user to change device settings (time, light/dark schedule, sensor sensitivity, metrics to record), to mount/eject the SD card, and to start/stop/pause recordings. The screen also displays the total number of licks for each sipper during recordings (which can be refreshed to the user's convenience) and will prompt the user if there are any errors, such as disconnected sensors or SD card.

In building the electronics, the Data Logger Shield and Touchscreen Shield was slightly modified to be made compatible with the Arduino Mega using the following steps. First, install the Shield Stacking Headers on the Data Logger Shield. Then, solder a wire connecting the CS pin to pin 7. On the underside of the Data Logger Shield, cut the thin connection on the CS solder pad by carefully etching with a sharp blade. On the Touchscreen Shield, create a solder bridge across the pads labeled “back lite #5” to allow for dimming of the screen during the animals' dark cycle. Mount the Data Logger Shield and the Touchscreen Shield onto the Arduino Mega by aligning and inserting the headers. The MPR121 breakout boards communicate with the Arduino Mega via I2C, which allows the microcontroller to communicate with multiple devices connected to the same pins if they have different I2C addresses. The MPR121 Board #1 will remain unmodified, but to modify the I2C address of the other MPR121 boards, solder a wire connection from “ADDR” to “3V” on one board (Board #2) and from “ADDR” to “SDA” on another (Board #3). Next, solder each pair of wires of the 2-pin connectors to the sensor pins (0-11). For consistency, red wires are soldered to even numbers, and black to odd numbers. We provide additional reinforcement from accidental wire detachment by applying a layer of hot glue over the solder points. Inputs 0-11 on Board #1 correspond to sensors 1-12 (cages 1-6), inputs 0-11 on Board #2 correspond to sensors 13-24 (cages 7-12), and Inputs 0-11 on Board #3 correspond to sensors 25-36 (cages 13-18). To connect the boards, attach the Qwiic cable with breadboard jumpers to the Arduino Mega (blue—pin 20, yellow—pin 21, red—5V, black—GND) and secure with hot glue. Connect the 4-way Qwiic Multiport Connector and plug in each MPR121 board with the Qwiic cables. Lastly, secure the device in the 3D-printed housing.

All 3D models were generated with Shapr3D and 3D-printed components were printed with PETG filament on an Ultimaker S5 printer. PETG was chosen for its high strength, durability, chemical resistance, ease of use, and food-safe properties. Bottles were printed with translucent filament and then coated internally with food-safe epoxy resin to prevent potential leaks and fill the space between printed layers. The in-cage device body was printed in pieces with black PETG. The legs were assembled to the upper portion with hot glue. For each device, two wire ends were soldered to the ends of two 3″×¼″ pieces of conductive copper tape. Copper tape is adhered to the inner part of each sipper clip, and wires are threaded up through the device body and out of the top. For consistency, red wire was used for the left side and black wire for the right side. Secure the sipper clips to the device legs with hot glue. Finally, solder the other 2-pin connectors to the device wires for easy connection to the MPR121 inputs.

The LIQ HD Arduino code was uploaded using the open-source Arduino IDE software (version 1.8.14 on MacOS). Users must first install the necessary libraries through the Arduino IDE before uploading the code. A detailed step-by-step guide, along with the Arduino code and 3D models, can be found at (https://github.com/nickpetersen93/LIQ_HD).

### Operation Instructions

In a particular embodiment, the device starts up with a splash screen followed by the device home page. The home page displays the date, time, and various buttons. Press the cogwheel icon to access the settings page, where the user can modify the date, time, light/dark cycle times, sensor sensitivity and auto calibration settings, parameters to record, bin size, and SD sync interval. Default settings are pre-loaded, but users should determine which sensor threshold works best for them. On the home page, the user can designate which side the “experimental” solution is on in the cages (i.e. sucrose, quinine, ethanol, etc.) before pressing “Start” to initiate recording. The SD card can also be mounted and ejected to allow for users to transfer data.

To begin recording, first ensure all devices are secured in the animal cages with the sippers properly placed in the clips. Connect each 2-pin wire connector prior to initiating the recording with the “Start” button. After “Start” is pressed, the screen will display the data file name for 2 seconds and the sensors will calibrate. It is vital that the animals are not actively drinking and that the user steps away from the device during calibration for accurate measurements. Data is logged in 1-minute bins and saved to the SD card every 10 minutes by default. On the recording page, the screen will display the cumulative lick number for the sippers in each cage. While these values are updated internally every minute, the user must press “Refresh” to display the updated values. The user also has the option to pause the recording with the “Pause” button. Pausing the recording prevents any new licks from being recorded, safely ejects the SD card for data transfer, and writes a line in the data spreadsheet indicating that the recording was paused. Upon pressing “Resume”, the SD card is mounted, the data file name will be displayed for 2 seconds, and the sensors will recalibrate. If the SD card fails or is removed at any point during the recording, the screen will display a warning along with the date and time that the recording failed. Rarely the I²C communication on the Arduino can lock up due to glitches or electrical interference. We have included a timeout detection in the code to identify lock-ups and resume recording without losing significant time. In this case, sensors will be restarted and recalibrated automatically. A line in the data will be logged if a timeout occurs. When the user has finished recording, pressing “Save & Quit” will sync any unsaved data to the SD card and return the device to the home page.

### Infrared Photobeam-Break Device Build

The IR photobeam-based drink monitoring device was built from 3D-printed parts and commercially available sensors and components. The design of the device was based on designs from Frie and Khokhar (2019) and Godynyuk et al. (2019) with modifications to allow for 16 cages to be recorded from a single Arduino Mega (FIG. 1G). Briefly, 3D-printed parts were printed and assembled as described above. Beam-break sensor boards were assembled as previously described (Frie and Khokhar, 2019; Godynyuk et al., 2019) and secured into the 3D-printed device. A total of 32 photobeam sensors were wired to the Arduino input/output pins. A 1.3″ OLED screen and two buttons were included to display total drink bout numbers for each cage and to operate the device. For this device, bout number is defined as the number of times the photobeam was interrupted and bout duration is the amount of time the beam was broken. Data were collected in one-minute increments.

Determination of Drinking Bouts with LIQ HD

Lick number is defined as the number of times the animal licked the sipper, while lick duration is defined as the actual contact time on the sipper. As previously described (Siciliano et al., 2019), the start of a drinking bout is defined as three licks in less than 1 second and the end of a drinking bout is defined as no licks within 3 seconds. Bout duration is defined as the bout time minus the 3-second deadtime at the end of each bout. Bout size is defined as the number of licks that occurred during each bout. The boutlick number is defined as the number of licks that occur only during bouts, and the boutlick duration is the sipper contact time only during bouts. Lick frequency, defined as licks per second during bouts, for each bin is calculated by dividing the total bout length by the total bout duration in seconds:

$$Lick Frequency ( Hz ) = \frac{Bout Length ( licks )}{Bout Duration ( sec )}$$

The estimated inter-lick interval is defined as the time between the offset of a lick and the onset of the subsequent lick. The average inter-lick interval for each bin is calculated by subtracting the total bout duration in milliseconds by the total bout lick duration and dividing by the total bout length:

$$Estimated Inter - Lick Intervals ( ms ) = \frac{Bout Duration ( ms ) - Bout Lick Duration ( ms )}{Bout Length ( licks )}$$

Bout microstructure did not significantly differ between the light and dark phase; thus, bout analysis is binned in 24-hour bins. Occasionally, the touch sensors do not release until touched again, which can erroneously inflate lick duration counts and be displayed in the data as bins with a lick duration value but without any recorded licks. For one-minute bins that have a lick duration value without a lick number value, or bins where the average lick duration (lick duration/lick number) was over 300 ms, lick duration was changed to 0.

### Animals

Female C57BL/6J mice (8 weeks of age) were purchased from Jackson Laboratory (#000664). Mice were allowed to habituate to the animal facility for at least 7 days before the start of experimentation. All mice were singly housed on a standard 12 hr light-dark cycle at 22-25° C. with food and water available ad libitum. All fluid measurements conducted by experimenters took place during the light phase. All experiments were approved by the Vanderbilt University Institutional Animal Care and Use Committee (IACUC) and were carried out in accordance with the guidelines set in the Guide for the Care and Use of Laboratory Animals of the National Institutes of Health.

### Two-Bottle Voluntary Choice Tasks

For each experiment, mice were singly housed in cages containing LIQ devices. Each device held two bottles. Every experiment began with a 7-day habituation period, during which both bottles contained only water, to allow the mice to acclimate to the housing conditions and the presence of two bottles. During this time no measurements were taken. Next, weights were taken every 48-72 hours (on Monday, Wednesday, and Fridays) for experiment 1 or every 7 days (every Friday) for experiment 2 to gain baseline fluid intake levels from both bottles containing only water. Bottle placement was swapped each time bottles were weighed to account for potential side biases. Following 7 days of water-only measurements, the fluid in one of the bottles was changed to either sucrose, quinine, or ethanol (as described below) while the second bottle remained filled with water. Again, for experiment 1 weights taken by experimenters every 48-72 hours (on Monday, Wednesday, and Fridays), and for experiment 2 weights were taken every 7 days (every Friday). As before, bottle placement was swapped every time bottles were weighed. For each experimental solution, a dose-response curve was performed in order from lowest to highest dose. For experiment 1, sucrose and quinine doses were each provided for 48-72 hours (72 hours for 0.5% sucrose and 48 hours each for 1% and 10% sucrose) before being switched to the next concentration. For experiment 2, 3% and 7% ethanol solutions were each provided for one week, followed by 4 weeks of 10% ethanol. The following doses were selected based on previous studies indicating altered intake and/or preference across a dose-response curve:

Sucrose: 0.5%, 1.0%, and 10% sucrose in tap water (Doyle et al., 2021; Glendinning et al., 2010; Zukerman et al., 2009)

Quinine: 0.01 g/L, 0.03 g/L, and 0.1 g/L in tap water (Hodge et al., 1999; Winters et al., 2021)

Ethanol: 3%, 7%, and 10% ethanol in tap water (Centanni et al., 2019; Hodge et al., 1999; Winters et al., 2021)

### Statistical Analysis

Data was first extracted and processed with a custom MATLAB script. Unless otherwise stated, data were binned into 1-hour bins. For the calculation of bottle preference over time, the binned data were smoothed with a moving average with a sliding window length of 6. Statistical analyses were performed with Prism 9 (GraphPad). Pearson correlation coefficients and simple linear regressions were computed for all correlation pairs. Repeated measures ANOVA with corrections for multiple comparisons were performed as indicated in the figure legends.

### Results

### Assessment of Modified Beam-Break Two-Bottle Choice System

The initial two-bottle choice pilot experiment conducted in the lab used a modified infrared (IR) beam break system (Frie and Khokhar, 2019; Godynyuk et al., 2019) (FIG. 1G) and singly housed female C57BL/6J mice. Specifically, the design of our device was adapted to make it compatible with mouse cages on our ventilated rack system (Lab Products Inc.) as well as to expand the volume the bottles could hold to 90 mL each. Following a week of habituating to two bottles containing water, four additional days of water-only availability were measured by the experimenter in daily sessions. This period was followed by a solution series, during which the fluid in one of the bottles was replaced with the following solutions: two consecutive days of 1% sucrose, one day of 10% sucrose, and one day of 0.1 g/L quinine. During this series, fluid intake was measured daily by an experimenter. To assess accuracy of the beam break-based measurements, the daily weight change values determined by experimenter intervention were correlated with the IR beam-break number and duration of bream-breaks recorded during the same recording period. When the data across the water and solution series were complied, we were able to closely replicate previous findings (Godynyuk et al., 2019) (FIG. 1H,1I). The correlation between total beam-break bout number and change in bottle weight (R²=0.3810, F_{(1, 85)}=52.31, p<0.0001) as well as the correlation between total beam-break bout duration (seconds) and change in bottle weight (R²=0.3844, F_{(1, 85)}=53.07, p<0.0001), were statistically significant. However, we encountered several issues with the photobeam sensors throughout the recording period. First, multiple devices required repair or replacement due to mice chewing and damaging the photobeam sensors. We also found that drips hanging from the bottom of the sippers would trigger the sensor and overcount bout duration. Mice would frequently attempt to bury the sensors with bedding, especially in the initial recording days, which also erroneously triggered the sensors. In the presented data, data points were removed in bins where the bout duration lasted an entire bin or where there was a recorded bout duration without a corresponding bout number.

### Assessment of LIQ HD Two-Bottle Choice System

While the data collected with the IR beam-break device significantly correlated with change in bottle weight and were nearly identical to published results, we sought to further improve on the accuracy and reliability of the behavioral recordings as well as increase the precision of the recorded data by designing a device, LIQ HD, that utilizes capacitive sensing technology to detect single licks. We took the modified design described above and replaced the IR beam-break sensors with a capacitance-sensing system. To validate the ability of LIQ HD to measure intake behaviors accurately, we performed a new series of two-bottle choice experiments with singly housed female C57BL/6J mice. Bottle weights were measured every 2-3 days (experiment 1) or every 7 days (experiment 2). Experiment 1 consisted of two groups of mice (8 mice each), where one group received a sucrose dose-response (0.5%, 1%, and 10% sucrose vs. water) and the other group received a quinine dose response (0.01 g/L, 0.03 g/L and 0.1 g/L quinine vs. water). In experiment 2, 16 mice went through a water-only two-bottle choice session, followed by 8 of those mice advancing through an additional ethanol dose-response paradigm (3%, 7% and 10% EtOH vs. water). In both experiments, mice were first habituated to the LIQ devices with water in both bottles for 1 week, where no measurements were taken, and then given an additional week of water only. For experiment 1, the experimental solutions (sucrose and quinine) were changed every 2-3 days, which coincided with weight measurements and swapping the sides of the bottles. For experiment 2, the ethanol and water bottles were weighed, changed, and swapped sides every 7 days. The LIQ HD and bottle measurement data from experiments 1 and 2 were combined to correlate the total lick numbers and total lick durations from each recording period with the corresponding bottle weight measurements (FIG. 1C, 1D). We observed a strong, significant correlation between both total lick number and change in bottle weight (R²=0.9174, F_{(1, 363)}=4034, p<0.0001) as well as total lick duration and change in bottle weight (R²=0.8623, F_{(1, 363)}=2273, p<0.0001), substantially higher R² values than were reported in IR beam-break based systems. The fitted regression model for the correlation between lick number and change in bottle weight is Y=736.4*X−1172 (slope 95% CI, 713.6 to 759.2). Thus, on average, the mice took 736 licks to drink 1 mL of fluid, or 1.4 μL per lick. As expected, total lick number and total lick duration also strongly correlate (R²=0.9720, F_{(1, 363)}=12601, p<0.0001) with a fitted regression model of Y=0.05132*X+8.027 (slope 95% CI, 0.050 to 0.052) (FIG. 1E). On average, the individual lick duration was 51 ms. These metrics are consistent with the literature (Bollu et al., 2021; Mundl and Malmo, 1979; Parkison et al., 2012; Rossi and Yin, 2015), providing further evidence that LIQ HD is detecting individual lick events with high fidelity. In our tests, the LIQ HD system ran reliably undisturbed between periods of bottle weight measurements for at least seven days (FIG. 1F).

### Experiment 1—LIQ HD Validation in Sucrose and Quinine Dose-Response Two-Bottle Choice Tasks

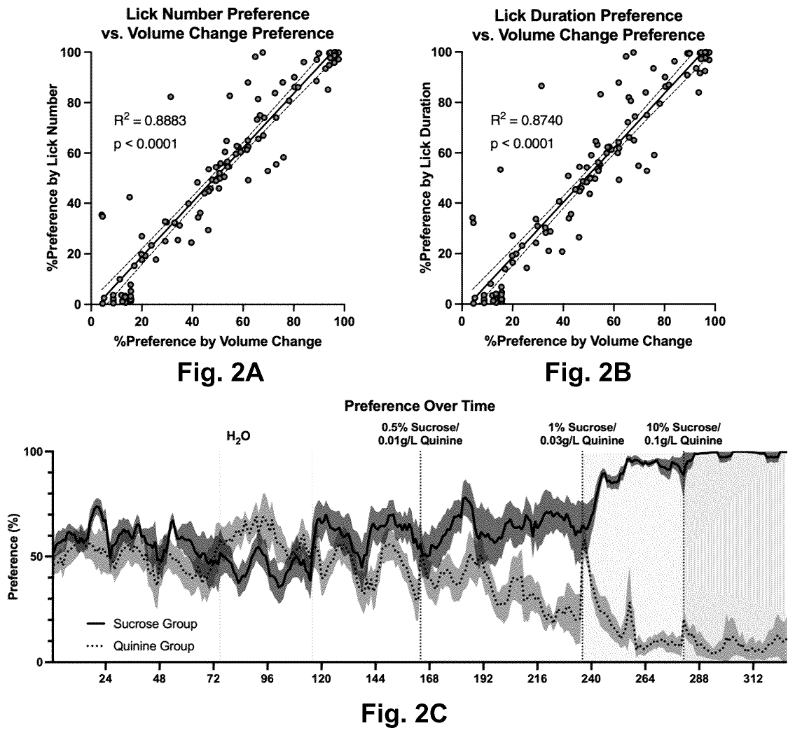

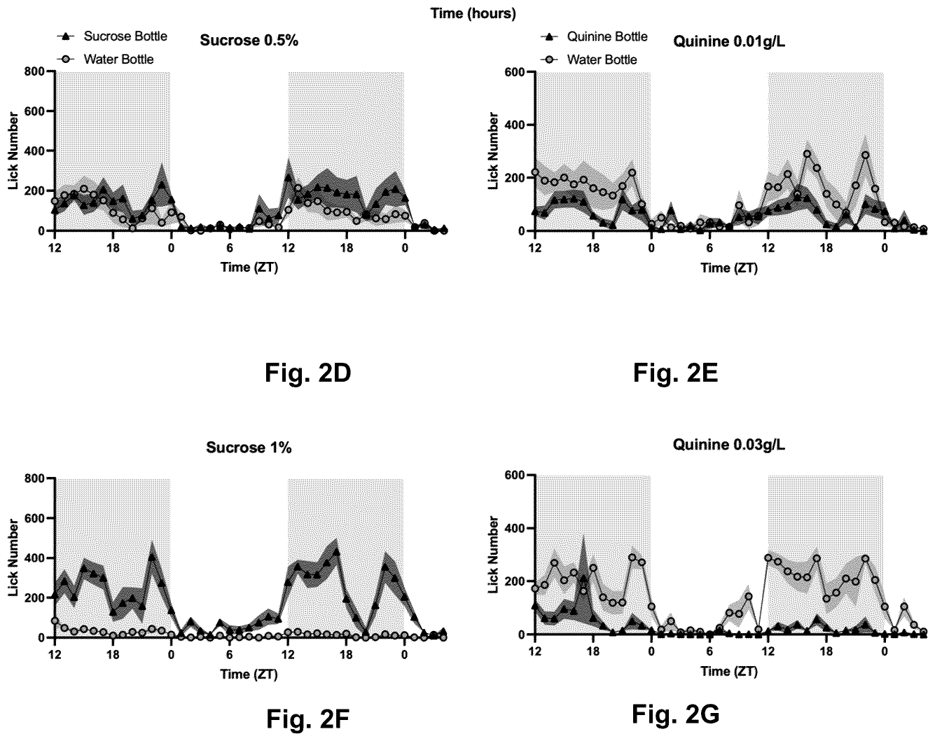

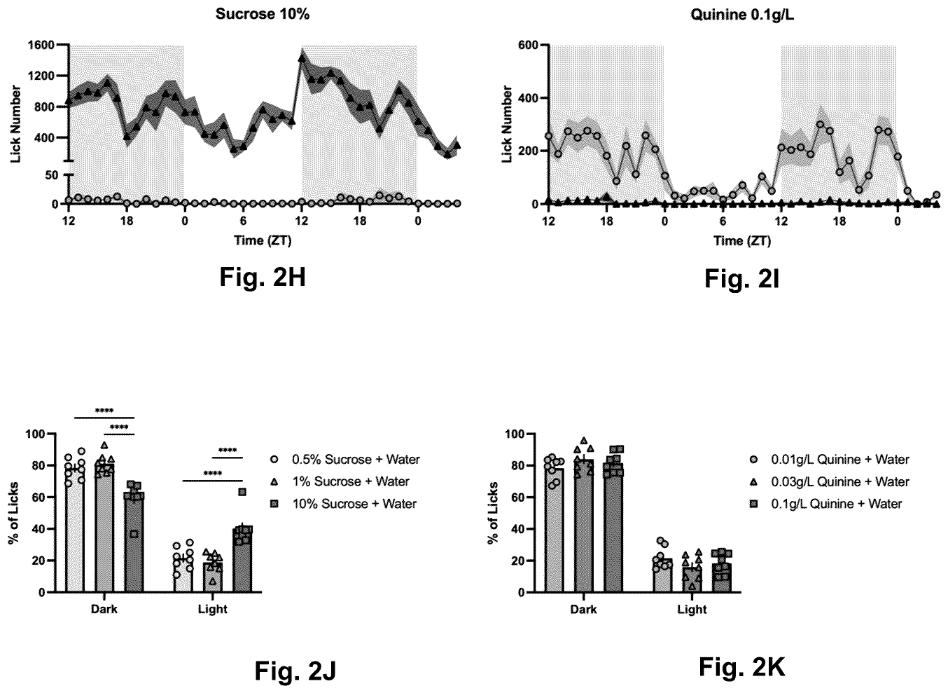

To test the LIQ HD system in common two-bottle choice paradigms, female C57BL/6J mice were split into two groups. One group underwent a two-bottle choice paradigm with a sucrose dose-response curve, and the other a quinine dose-response curve. Bottles were weighed and swapped sides every 2-3 days. When the recorded data were aggregated, we observed a strong, significant correlation between preference score calculated by total lick number and preference score calculated by bottle weight change (R²=0.8883, F_{(1, 110)}=874.5, p<0.0001) as well as between preference score calculated by total lick duration and preference score calculated bottle weight change (R²=0.8740, F_{(1, 110)}=763, p<0.0001) (FIG. 2A,B). Additionally, with the added temporal resolution of LIQ HD over standard experimenter-determined measures, we also investigated changes in drink preference over time (FIG. 2C). As expected, preference for the sucrose bottle over water increased with increasing concentrations of sucrose, and preference for the quinine bottle over water decreased with increasing concentrations of quinine (FIG. 2C). Moreover, we examined changes in drinking behaviors over the light and dark cycle to detect potential deviations from the typical circadian drinking patterns, with examples displayed in FIGS. 2D-2I. Overall, for the percent of total licks occurring per cycle in the sucrose group there was a significant main effect of light cycle (F_{(1, 21)}=209.7, p<0.0001) and interaction of light cycle x sucrose concentration (F_{(2,21)}=17.64, p<0.0001). While the mice increased their total licks at the sucrose bottle as the sucrose concentration was increased from 0.5% to 1% sucrose, the percentage of the overall licks that occurred during the light and dark phases did not change (FIG. 2J). In addition to further increasing total licks at the sucrose bottle during access to 10% sucrose (FIG. 2H), the mice also displayed a unique increase in percent of sucrose consumption occurring during the light phase (0.5% vs 10% sucrose, p<0.0001, 1% vs 10% sucrose, p<0.0001), and corresponding decrease in the dark phase (0.5% vs 10% sucrose, p<0.0001, 1% vs 10% sucrose, p<0.0001) (FIG. 2J). Mice exposed to increasing concentrations of quinine with water did not display any changes in the light cycle drinking pattern (FIG. 2K) (significant main effect of light cycle only, F_{(1, 21)}=485.5, p<0.0001). Taken together, these data indicate that LIQ HD can accurately and consistently record overall preference scores, preference over time, and light cycle-dependent drinking patterns in classic two-bottle choice paradigms.

### Experiment 2—LIQ HD Bout Detection and Microstructure Analysis in a Prolonged Ethanol Two-Bottle Choice Task

Because LIQ HD was able to accurately quantify behavioral data from sucrose and quinine two-bottle choice tasks, we next sought to validate its use in longer duration tasks. To do this, we turned to a 6-week continuous access ethanol two-bottle choice task. Further, given that LIQ HD can detect individual lick events, we sought to determine if the system is able to detect drinking bouts and record bout microstructure. To do this, we coded bout detection directly to the main LIQ HD Arduino code, where a “bout” begins when an animal licks at least 3 times within 1 second and ends when no licks have occurred over 3 seconds (Siciliano et al., 2019). With this we can also determine the lick number and lick duration during bouts, which allows us to calculate lick frequency and an estimated inter-lick interval.

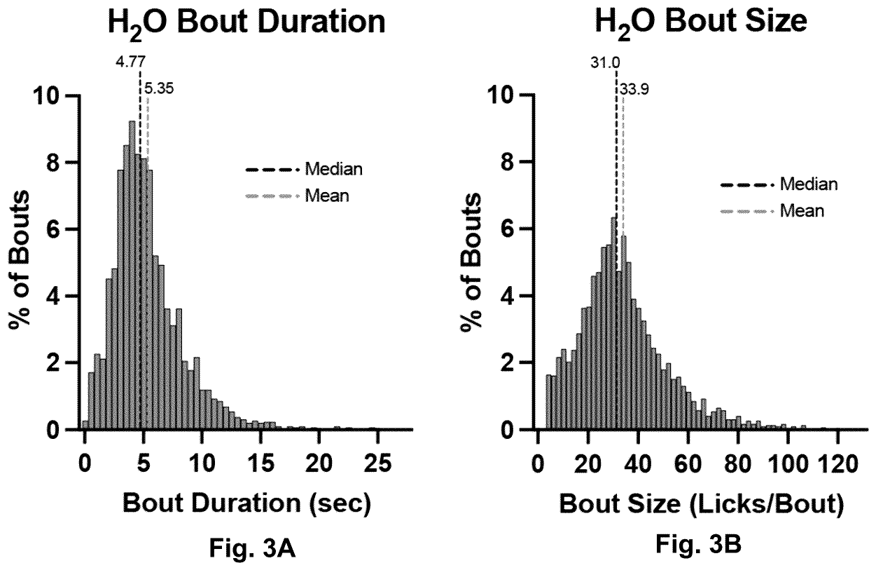

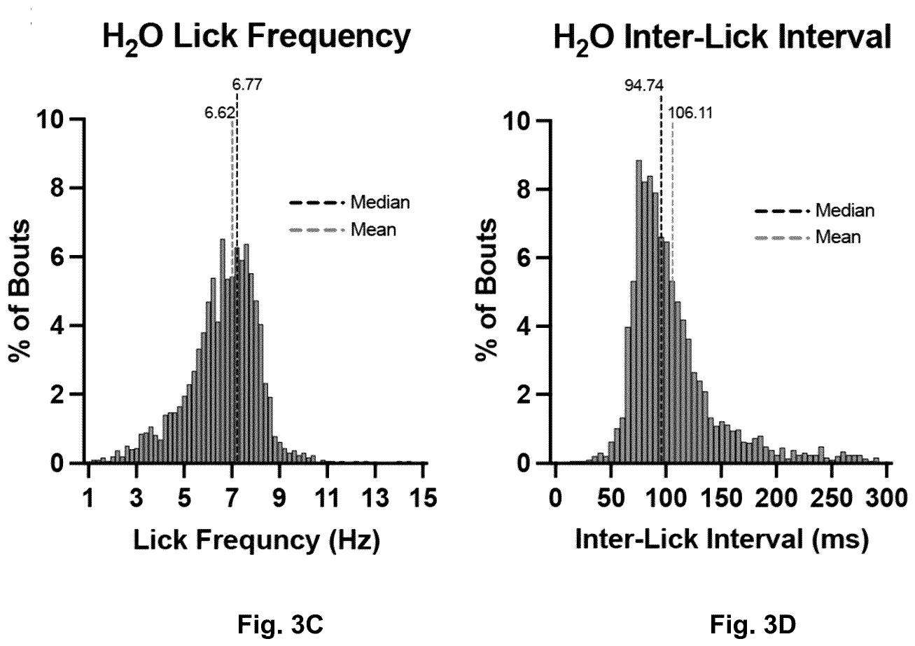

First, to test the LIQ HD bout detection, 16 female C57BL/6J mice underwent a two-bottle choice task with access to two water bottles. Mice were first habituated for 1 week with a LIQ device with water in both bottles, during which no measurements were taken. Water-related measurements were then taken during a subsequent week of water-only access. We also sought to determine if LIQ HD is capable to run for prolonged undisturbed recording periods, thus experimenter measurements of bottle weights were taken only every 7 days. The LIQ data from each sipper (16 cages, 32 sippers) was binned into 1-hour bins and the average individual bout duration, bout size, bout lick frequency, and bout estimated inter-lick interval were calculated. Estimated inter-lick interval values >300 ms were excluded from the analysis. The mean and median individual bout duration (seconds) during the water drinking period (n=2919) were 5.35±0.06 (SEM) and 4.77 (IQR 3.34 to 6.67) (FIG. 3A). The mean and median of individual bout size (licks per bout) during the water drinking period (n=2914) were 33.9±0.34 (SEM) and 31.0 (IQR 22.0 to 42.5) (FIG. 3B). The mean and median of lick frequency (Hz) (n=2915) were 6.62±0.03 (SEM) and 6.77 (IQR 5.81 to 7.63) (FIG. 3C). The mean and median of estimated inter-lick interval (milliseconds) during the water drinking period (n=2858) were 106±0.79 (SEM) and 94.7 (IQR 79.1 to 118) (FIG. 3D). These findings are consistent with results from previous studies (Bollu et al., 2021; Boughter et al., 2007; Johnson et al., 2010; Parkison et al., 2012; Raymond et al., 2018).

Following the LIQ bout detection validation, 8 of the female C57BL/6J mice underwent a two-bottle choice ethanol drinking paradigm. The two-bottle choice paradigm consisted of an ethanol ramp where one of the water bottles was replaced with an ethanol solution. During the ramp, mice received one week of 3% ethanol, one week of 7% ethanol, and four weeks of 10% ethanol. As stated above, the system can accurately and consistently record drinking behavior over a 7-day period (FIG. 1F). Moreover, LIQ HD withstood 8 weeks (including water only access and habituation) of continuous usage without any devices needing repair or replacement during experimentation.

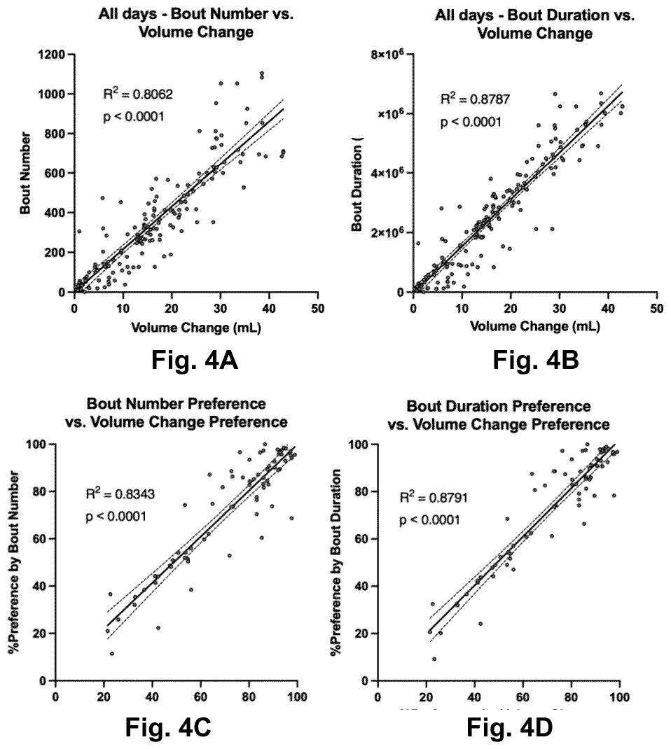

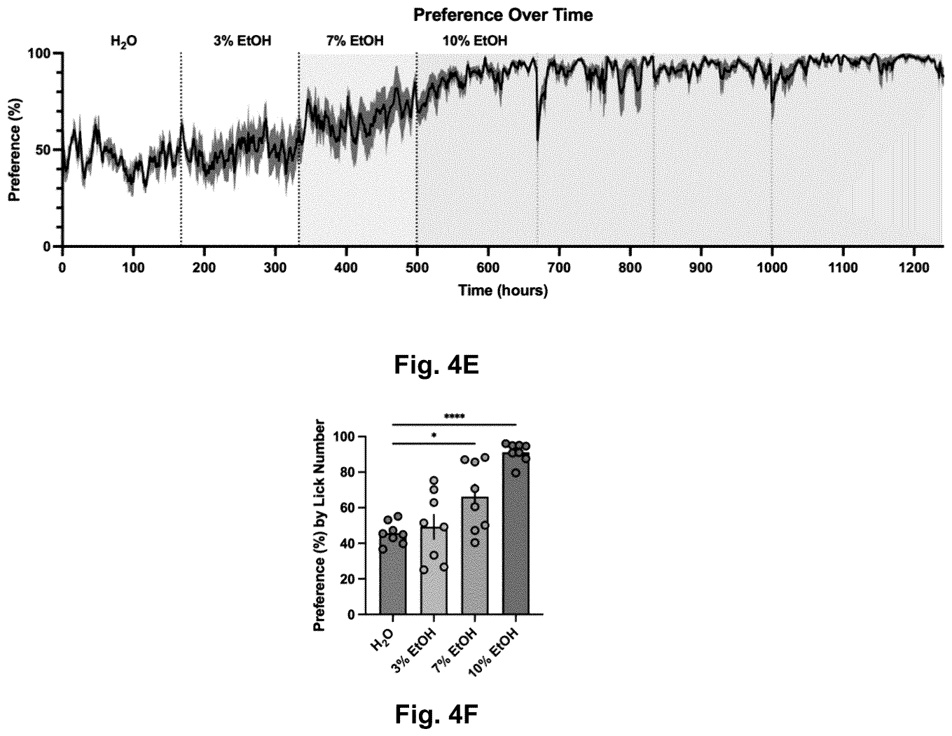

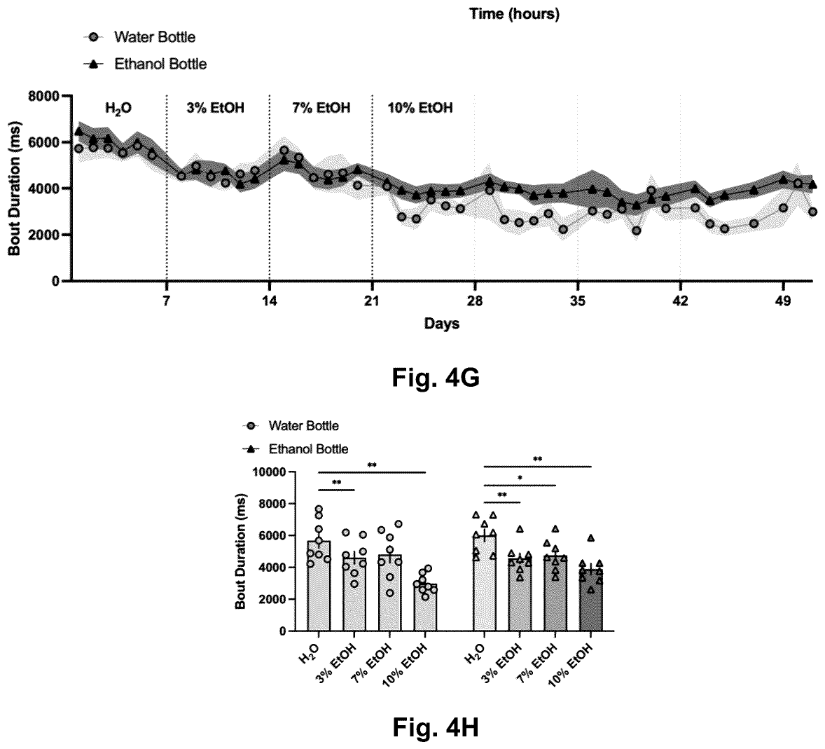

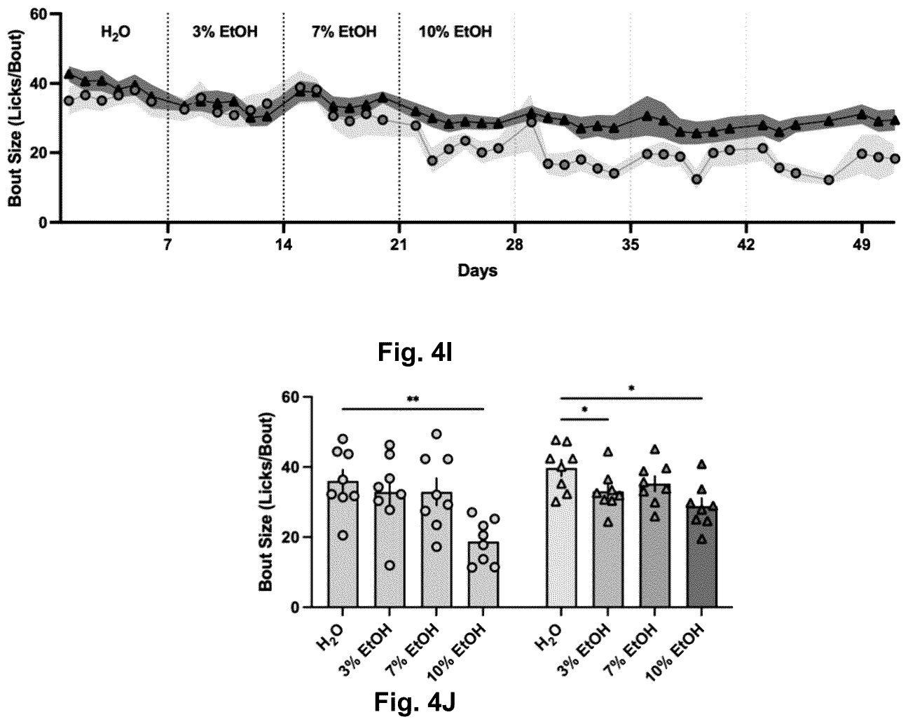

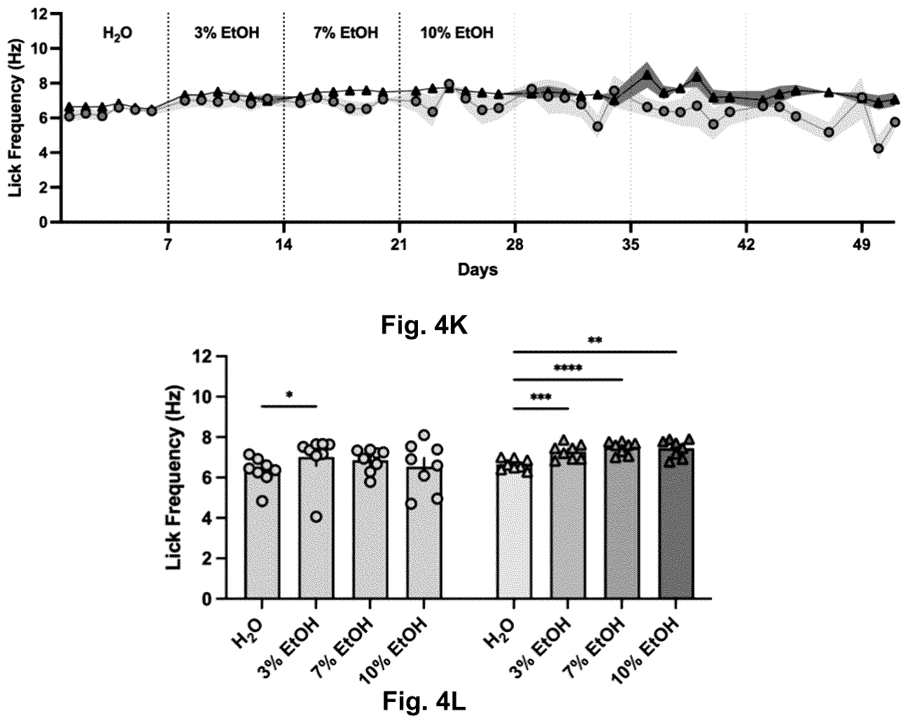

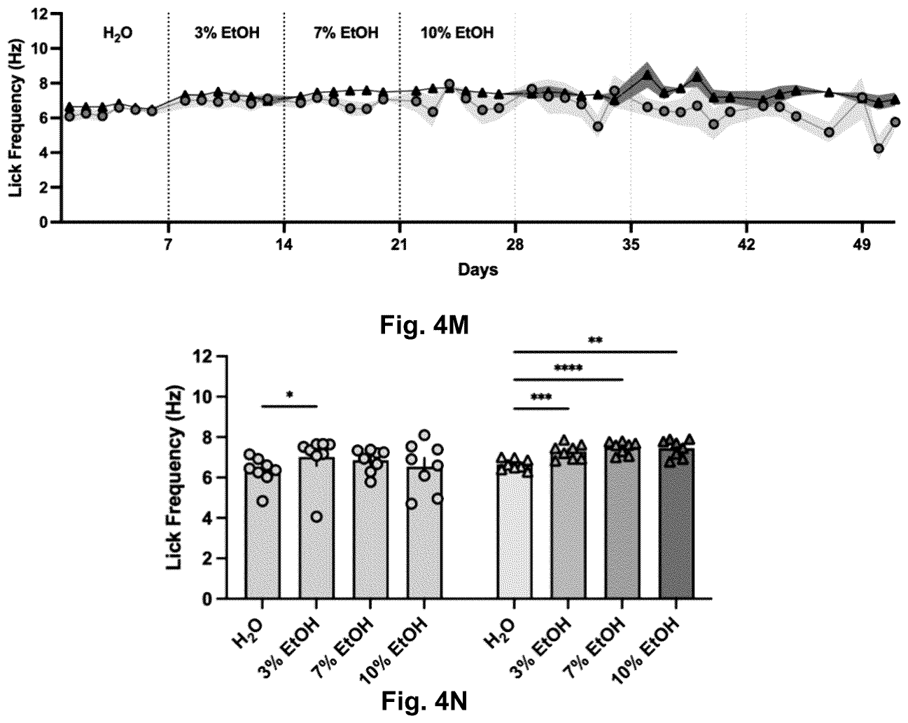

To determine the correlation of bout number and bout duration with change in bottle weight, as well as the correlation of preference score calculated by bout number and bout duration with the preference score calculated by change in bottle weight, the water two-bottle choice and ethanol two-bottle choice data were aggregated. We observed a strong, significant correlation between total bout number and change in bottle weight (R²=0.8062, F_{(1, 156)}=648.8, p<0.0001) as well as between total bout duration and change in bottle weight (R²=0.8787, F_{(1, 156)}=1130, p<0.0001) (FIG. 4A, 4B). The fitted regression models for bout number versus change in bottle weight and bout duration versus change in bottle weight are Y=21.51*X+0.8541 (slope 95% CI, 19.84 to 23.17) and Y=157.533*X−37270 (slope 95% CI, 148.276 to 166.790), respectively. These data indicate that on average mice drink 1 mL over 21.5 bouts, or 46.5 μL per bout, and on average take 157.5 seconds to drink 1 mL during bouts, or 6.35 μL per second. We also found a strong, significant correlation between preference score calculated by total bout number and preference score calculated by bottle weight change (R²=0.8343, F_{(1, 69)}=347.4, p<0.0001) as well as between preference score calculated by total bout duration and preference score calculated by bottle weight change (R²=0.8791, F_{(1, 69)}=501.8, p<0.0001) (FIG. 4C,4D). While bout number and bout duration may not be as reliable of a predictor of total change in bottle weight compared to total lick number (R²=0.9174), these data suggest that the LIQ HD bout detection software can accurately detect individual clustered drinking events throughout long recording periods.

In addition to preference over time in the prolonged ethanol two-bottle choice paradigm, where mice showed expected significantly elevated preference for both 7% ethanol (p=0.0481) and 10% ethanol (p<0.0001) compared to water (FIG. 4E-4F), LIQ HD can also be used to analyze drinking bout microstructure over time (FIG. 4G-4L). Bout microstructure data were grouped into 24-hour bins, as we did not observe differences between the light and dark cycle (data not shown). Throughout this increasing preference for ethanol, the average bout duration, bout size, lick frequency and estimated inter-lick interval were altered. Although bouts at the ethanol bottle became more frequent compared to those at the water bottle, access to ethanol significantly decreased the average bout duration (significant main effect of ethanol concentration, F_{(20.129, 290.80)}=23.68, p<0.0001) at both the water bottle (H₂O vs. 3% EtOH, p=0.0096, H2O vs. 10% EtOH, p=0.0022) and the ethanol bottle (H2O vs. 3% EtOH p=0.0055, H2O vs. 7% EtOH, p=0.0310, H2O vs. 10% EtOH, p=0.0054) (FIG. 4H). Bout size also significantly decreased (significant main effect of ethanol concentration, F_{(1.882, 260.34)}=17.01, p<0.0001) at the ethanol bottle during ethanol exposure (H2O vs. 3% EtOH, p=0.0288, H2O vs. 10% EtOH, p=0.0189), but only decreased at the water bottle during exposure to the highest ethanol dose (H2O vs. 10% EtOH, p=0.0047) (FIG. 4J). Interestingly, lick frequency significantly increased (significant main effect of ethanol concentration, F_{(20.300, 320.20)}=8.236, p=0.0008) at the ethanol bottle at all doses (H2O vs. 3% EtOH, p=0.0005, H2O vs. 7% EtOH, p<0.0001, H2O vs. 10% EtOH, p=0.0017) with a concurrent decrease in the estimated inter-lick interval (significant main effect of ethanol concentration, F_{(20.300, 320.20)}=8.236, p=0.0008, significant interaction ethanol concentration x bottle F_{(3, 42)}=3.801, p=0.0169, H2O vs. 3% EtOH, p=0.0002, H2O vs. 7% EtOH, p<0.0001, H2O vs. 10% EtOH, p=0.0236) (FIG. 4L). We only observed an increase in lick frequency at the water bottle during access to 3% ethanol (H2O vs. 3% EtOH, p=0.0434) without any significant differences in estimated inter-lick interval (FIG. 4L). Overall, these data replicated known effects of prolonged, continuous access to increasing concentrations of ethanol in an undisturbed home cage environment on preference for ethanol over water and revealed significant changes to the bout lick microstructure in female C57BL/6J mice.

### Discussion

Here we present LIQ HD, Lick Instance Quantifier Home cage Device, a capacitance sensor-based two-bottle choice open-source system capable of detecting undisturbed licking behavior in a true rodent home cage environment. A single LIQ HD Arduino system records drinking behavior in up to 18 cages. The system includes a touchscreen with a graphical user interface for an intuitive user experience. LIQ HD detects single lick events, and lick number and duration strongly correlate with change in liquid volume as measured by manually weighing the bottles. The use of capacitive sensors significantly outperformed our modified beam-break sensor based device (R² of 0.9174 versus 0.3844), which closely matched the accuracy of other beam-break devices (Godynyuk et al., 2019). Additionally, each 3D-printed bottle holds roughly 90 mL of liquid, allowing for prolonged, undisturbed recording sessions. In this study we utilized LIQ HD continuously for several months with undisturbed recordings lasting up to 7 days. We observed that female C57BL/6J mice drank about 7 mL of water per day, suggesting that the system could potentially run for multiple weeks undisturbed. It is important to note that the maximum length of the recording period will depend on preference values, mouse strain (Bachmanov et al., 2002), and the animal housing regulations of the research institution.

In a series of two-bottle choice paradigms, we show that LIQ HD accurately measures drink preference, and the minute-by-minute data also allow for the analysis of circadian drinking patterns. For example, here we show that access to 10% sucrose shifts the typical dark/light drinking pattern, with a significantly greater percentage of licks occurring in the light phase and less in the dark phase when compared to 0.5% or 1% sucrose availability (FIG. 2J). These features may be helpful in studying individual differences in drinking behaviors, such as investigating differences in the acquisition of drink preference or susceptibility to circadian dysregulation. Moreover, the ability of the LIQ HD to detect individual licks allows for analysis of the mouse bout microstructure, further simplified by our software which detects bouts directly from the Arduino source code. While it is challenging to compare lick microstructure across various experimental modalities, such as unlimited continuous access, intermittent access, operant conditioning tasks, etc., our baseline bout microstructure measurements are consistent with the data in the literature (Bollu et al., 2021; Boughter et al., 2007; Johnson et al., 2010; Parkison et al., 2012; Raymond et al., 2018). Utilizing this bout detection and microstructure system, we observed significant changes to drinking structure over time in a classic ethanol two-bottle choice task. Taken together, LIQ HD can be utilized to investigate drinking behavior and bout microstructure with high temporal resolution and accuracy for two-bottle choice tasks with prolonged undisturbed recording periods.

The capacitance-sensing LIQ HD system has several advantages compared to currently available IR photobeam-break devices. In addition to significantly improved accuracy and ventilated rack compatibility, the LIQ HD devices are more resilient. In our experience, photobeam sensors were frequently subject to destruction by rodent chewing. In the LIQ HD system, if the sipper remains in contact with the conductive copper foil tape, LIQ HD will continue to detect licks, creating a low likelihood that a mouse could destroy the device to the point that it malfunctions. During these experiments and initial pilot studies, the 16 LIQ HD devices ran for >100 days without any device failures. It is possible that if used with rats or animals with increased chewing behavior, such stress- or opioid-exposed mice, the 3D-printed clips that secure the copper tape and sipper will require more frequent repair. However, we expect some damage and have accordingly designed the device so that the clip is easily removable and replaceable. Moreover, the capacitive sensor boards communicate with the Arduino controller though I²C communication rather than through the direct input/output pins on the microcontroller. This allows for many devices to run off a single Arduino, as the system is no longer limited to the number of available pins but rather the ability of the sensor boards to have unique I²C addresses. In its current state LIQ HD utilizes 3 12-channel MPR121 capacitive sensor boards, for a total of 36 sippers, but it can be readily expanded by the end user to use 4 boards for 48 sippers. With the addition of an I²C address multiplexer, users can connect multiple sensor boards that have the same address, further scaling LIQ HD.

Like any open-source system, LIQ HD has several limitations when considering its use. Unlike battery-powered systems, the current system must be continuously plugged into an outlet and will stop recording if power is lost. The capacitive sensors may also be subject to electrical interference if not properly grounded. To avoid this interference, the listed power supply contains a grounding prong, and we recommend an additional grounding wire from the Arduino to another grounding source. The system, however, could be modified to be battery-operated or have a battery backup. Also, because electrical wires increase capacitance and thus affect sensor sensitivity, wire lengths connecting cages should be kept consistent and as short as possible. Finally, LIQ HD is limited by the same factors that limit most two-bottle choice systems, such as that animals are singly housed and periodic switching of bottle sides should be implemented to avoid side bias. The system can be modified to include a barrier (such as plexiglass) to physically separate mice in a housing to prevent the mice from accessing each other's water bottles.

To conclude, LIQ HD is an affordable, easy-to-build, multi-home cage lickometer system that utilizes capacitive sensors for accurate lick detection. The devices hold sufficient liquid bottle weight change in two-bottles for prolonged undisturbed recordings of drinking behavior and bout microstructure and are highly resistant to functional damage from rodent manipulation. The current system is designed to record up to 18 cages simultaneously, and its precision can eliminate the need for cumbersome bottle weighing, thus rendering it suitable for high-throughput experiments. We encourage users to utilize the open-source code and designs to expand upon our current system to make LIQ HD compatible with other home cages, increase the scale of recordings, and improve overall efficiency.

### EXAMPLE 1 REFERENCES

1. Bachmanov, A. A., Reed, D. R., Beauchamp, G. K., and Tordoff, M. G. (2002). Food intake, water intake, and drinking spout side preference of 28 mouse strains. Behav. Genet. 32, 435-443.
2. Bollu, T., Ito, B. S., Whitehead, S. C., Kardon, B., Redd, J., Liu, M. H., and Goldberg, J. H. (2021). Cortex-dependent corrections as the tongue reaches for and misses targets. Nature 594, 82-87.
3. Boughter, J. D., Baird, J. P., Bryant, J., St. John, S. J., and Heck, D. (2007). C57BL/6J and DBA/2J mice vary in lick rate and ingestive microstructure. Genes, Brain Behav. 6, 619-627.
4. Centanni, S. W., Morris, B. D., Luchsinger, J. R., Bedse, G., Fetterly, T. L., Patel, S., and Winder, D. G. (2019). Endocannabinoid control of the insular-bed nucleus of the stria terminalis circuit regulates negative affective behavior associated with alcohol abstinence. Neuropsychopharmacology 44, 526-537.
5. Dole, V. P., Ho, A., and Gentry, R. T. (1983). An improved technique for monitoring the drinking behavior of mice. Physiol. Behav. 30, 971-974.
6. Doyle, M. A., Bali, V., Eagle, A. L., Stark, A. R., Fallon, B., Neve, R. L., Robison, A. J., and Mazei-Robison, M. S. (2021). Serum- and glucocorticoid-inducible kinase 1 activity in ventral tegmental area dopamine neurons regulates cocaine conditioned place preference but not cocaine self-administration. Neuropsychopharmacology 46, 1574-1583.
7. Frie, J. A., and Khokhar, J. Y. (2019). An open source automated two-bottle choice test apparatus for rats. HardwareX 5, e00061.
8. Glendinning, J. I., Breinager, L., Kyrillou, E., Lacuna, K., Rocha, R., and Sclafani, A. (2010). Differential effects of sucrose and fructose on dietary obesity in four mouse strains. Physiol. Behav. 101, 331-343.
9. Godynyuk, E., Bluitt, M. N., Tooley, J. R., Kravitz, A. V, and Creed, M. C. (2019). An Open-Source, Automated Home-Cage Sipper Device for Monitoring Liquid Ingestive Behavior in Rodents. Eneuro 6, ENEURO.0292-19.2019.
10. Hodge, C. W., Mehmert, K. K., Kelley, S. P., McMahon, T., Haywood, A., Olive, M. F., Wang, D., Sanchez-Perez, A. M., and Messing, R. O. (1999). Supersensitivity to allosteric GABA(A) receptor modulators and alcohol in mice lacking PKCE. Nat. Neurosci. 2, 997-1002.
11. Johnson, A. W., Sherwood, A., Smith, D. R., Wosiski-Kuhn, M., Gallagher, M., and Holland, P. C. (2010). An analysis of licking microstructure in three strains of mice. Appetite 54, 320-330.
12. Longley, M., Willis, E. L., Tay, C. X., and Chen, H. (2017). An open source device for operant licking in rats. PeerJ 2017, 1-15.
13. Melo, M. C., Alves, P. E., Cecyn, M. N., Eduardo, P. M. C., and Abrahao, K. P. (2022). Development of eight wireless automated cages system with two lick-o-meters each for rodents. Eneuro ENEURO.0526-21.2022.
14. Mingrone, A., Kaffman, A., and Kaffman, A. (2020). The Promise of Automated Home-Cage Monitoring in Improving Translational Utility of Psychiatric Research in Rodents. Front. Neurosci. 14, 1-8.
15. Mundl, W. J., and Malmo, H. P. (1979). Capacitive sensor for lick-by-lick recording of drinking. Physiol. Behav. 22, 781-784.
16. Parkison, S. A., Carlson, J. D., Chaudoin, T. R., Hoke, T. A., Schenk, A. K., Goulding, E. H., Perez, L. C., and Bonasera, S. J. (2012). A low-cost, reliable, high-throughput system for rodent behavioral phenotyping in a home cage environment. In 2012 Annual International Conference of the IEEE Engineering in Medicine and Biology Society, (IEEE), pp. 2392-2395.
17. Raymond, M. A., Mast, T. G., and Breza, J. M. (2018). An open-source lickometer and microstructure analysis program. HardwareX 4, 1-10.
18. Rossi, M. A., and Yin, H. H. (2015). Elevated dopamine alters consummatory pattern generation and increases behavioral variability during learning. Front. Integr. Neurosci. 9, 1-12.
19. Schoenbaum, G., Garmon, J. W., and Setlow, B. (2001). A novel method for detecting licking behavior during recording of electrophysiological signals from the brain. J. Neurosci. Methods 106, 139-146.
20. Siciliano, C. A., Noamany, H., Chang, C.-J., Brown, A. R., Chen, X., Leible, D., Lee, J. J., Wang, J., Vernon, A. N., Vander Weele, C. M., et al. (2019). A cortical-brainstem circuit predicts and governs compulsive alcohol drinking. Science (80-.). 366, 1008-1012.
21. Ulman, E. A., Compton, D., and Kochanek, J. (2008). Measuring Food and Water Intake in Rats and Mice. ALN Mag. 17-20.
22. Weijnen, J. A. W. M. (1998). Licking behavior in the rat: Measurement and situational control of licking frequency. Neurosci. Biobehav. Rev. 22, 751-760.
23. Winters, N. D., Bedse, G., Astafyev, A. A., Patrick, T. A., Altemus, M., Morgan, A. J., Mukerjee, S., Johnson, K. D., Mahajan, V. R., Uddin, M. J., et al. (2021). Targeting diacylglycerol lipase reduces alcohol consumption in preclinical models. J. Clin. Invest. 131.
24. Zukerman, S., Glendinning, J. I., Margolskee, R. F., and Sclafani, A. (2009). T1R3 taste receptor is critical for sucrose but not Polycose taste. Am. J. Physiol.—Regul. Integr. Comp. Physiol. 296, 866-876.

### Example 2

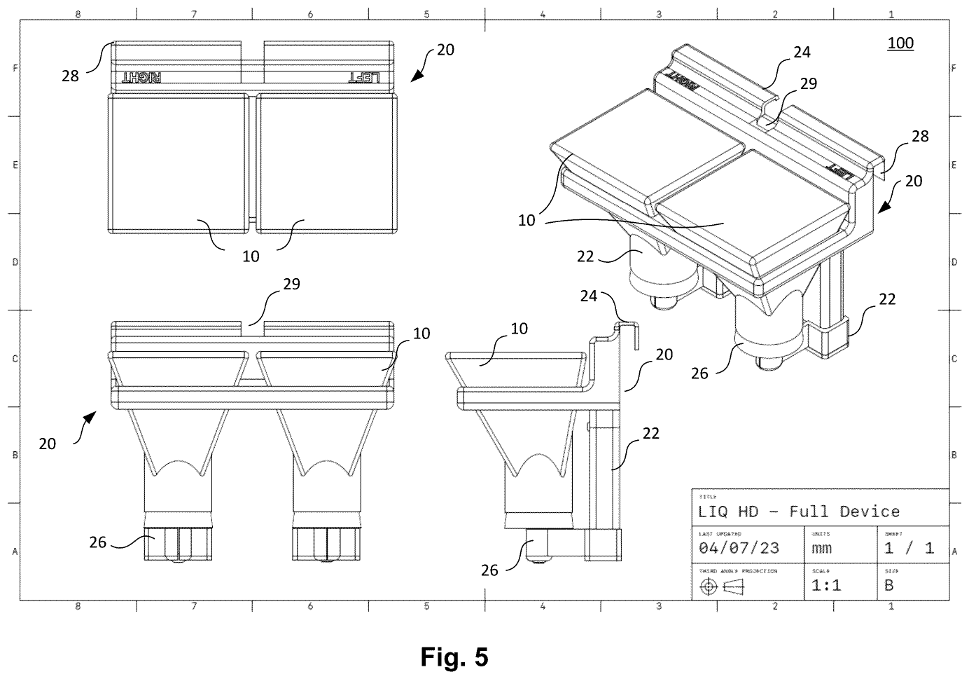

The system can be better understood while referencing the figures. Turning now to FIGS. 5-10, a particular embodiment of the LIQ HD system is shown, although it is not intended to be limiting. The system comprises a device 100.

FIG. 5 shows an illustration of device 100, where left and right denote the user view from outside the cage. The device 100 as shown includes two bottles 10 that are supported by a frame 20. The frame 20 includes a leg 22 for each bottle and a top portion 24 equipped with a pair of hangers 28. A sipper clip 26 is mounted on each leg 22 to receive the sipper portion 12 of the bottle 10. Bottle openings 25 receive the bottles 10. Wiring notch 29 is located between hangers 28.

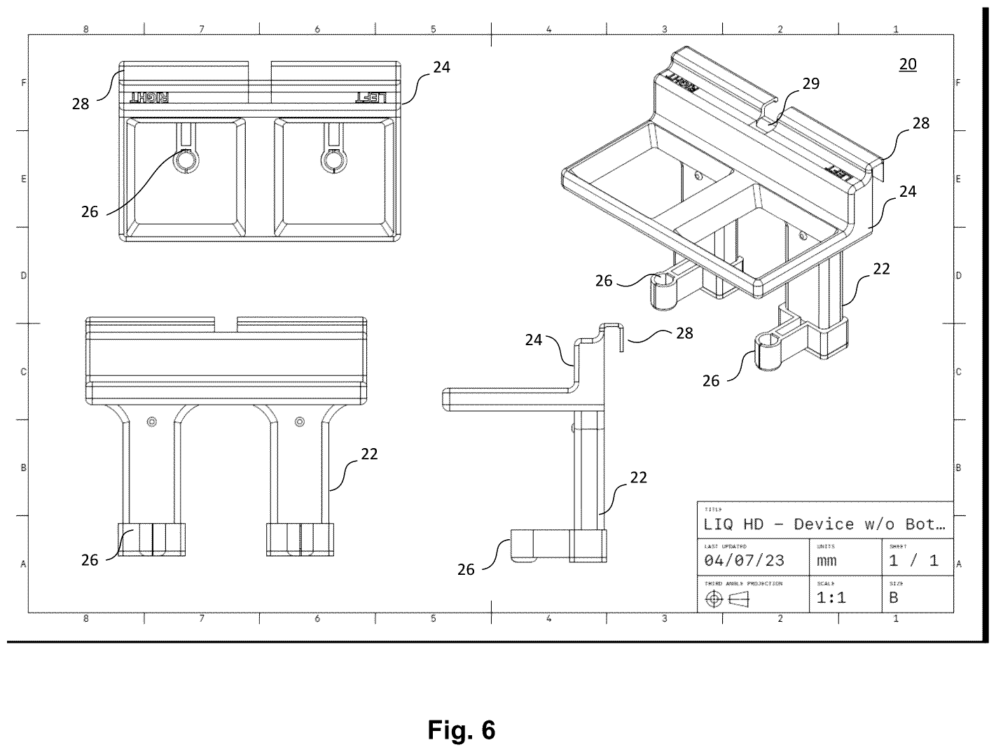

FIG. 6 shows frame 20 without the bottles 10 inserted.

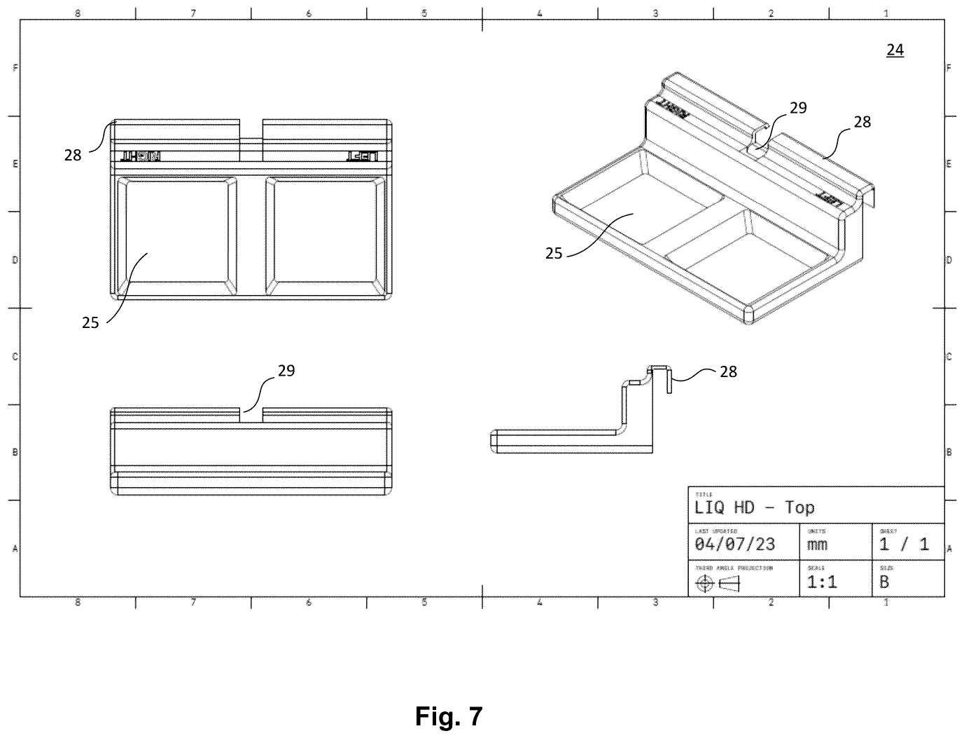

FIG. 7 shows the top portion 24.

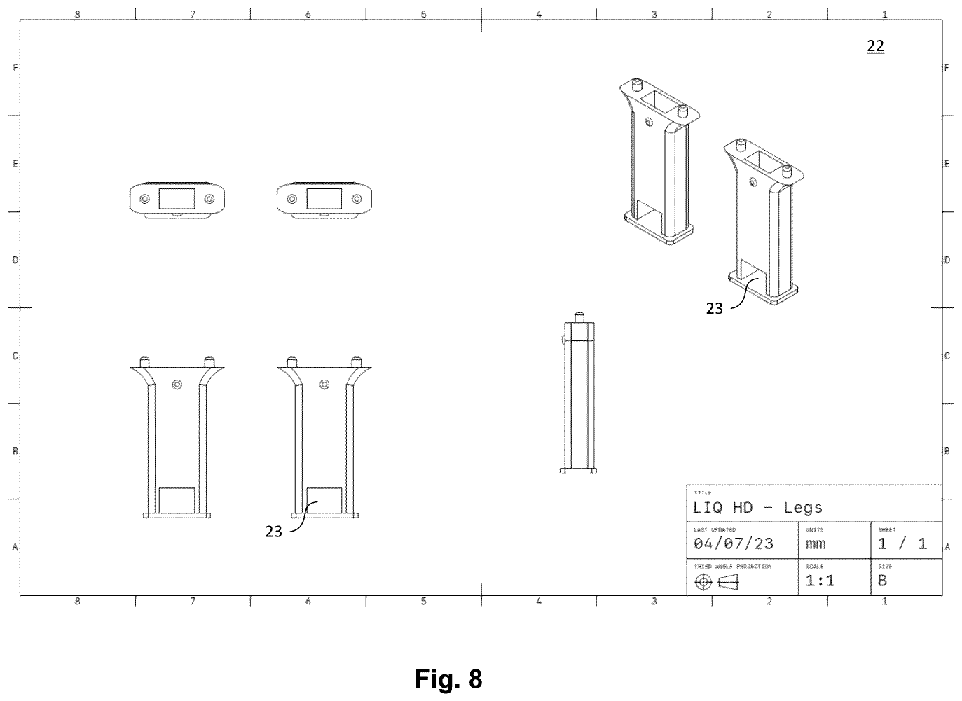

FIG. 8 shows the legs 22. In the pictured embodiment, legs 22 have two pegs on the top side which snap into corresponding holes on the underside of top portion 24 (not shown). The peg shape and arrangement are not intended to be limiting and legs 22 could be fastened to the frame 20 by other common configurations. In alternative embodiments, the top portion 24 can have pegs received by complementary holes in legs 22 or can have a rectangular projection that mates with the rectangular opening 23 on the top of leg 22. In other embodiments, the legs 22 are shown here as hollow, but could be manufactured as a solid piece, as can be envisioned by one of ordinary skill in the art. In a solid embodiment, a channel or tube to receive wiring could be included on the back of the device or the circuitry could be embedded such that it interfaces with the detachable sipper clip 26. An embedded design would prevent bedding and other detritus from entering the sipper clip 26.

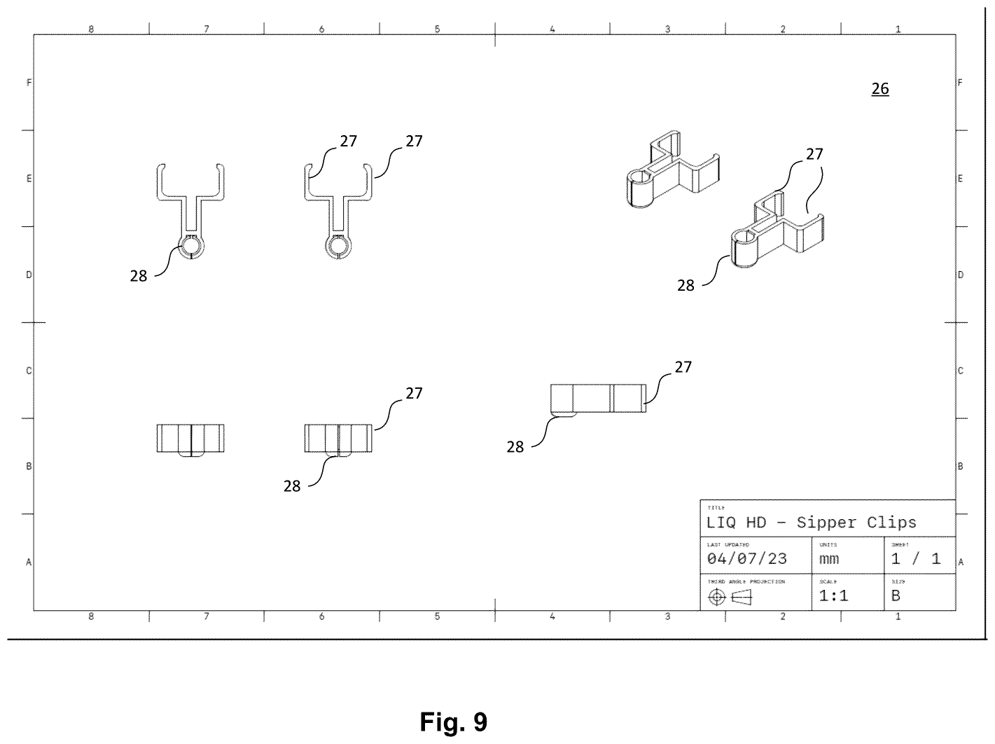

As shown in FIG. 9, sipper clip 26 has arms 27 that clip around leg 22 and stay in place with tension. In other embodiments, leg 22 can have a ledge to support sipper clip 26. In other embodiments, the sipper clip 26 can have a closed shape in place of the arms 27 where the sipper clip 26 is tightly slotted over leg 22. In yet another embodiment, the arms 27 can be reversed such that they insert into the rectangular opening 23 in the bottom of leg 22 such that the arms 27 stay in place with outward expansion. Sipper clip 26 also has a sipper receiver clip to receive the sipper 12 of bottle 10. At least the portion of sipper clip 26 that contacts sipper 12 is lined with conductive material, (e.g., copper tape) for conduction (see FIG. 1A). The sipper clip serves as both the means for conducting a signal and covers the sipper to minimize occurrences of the sensor from being set off by non-lick touch, e.g., paw contact.

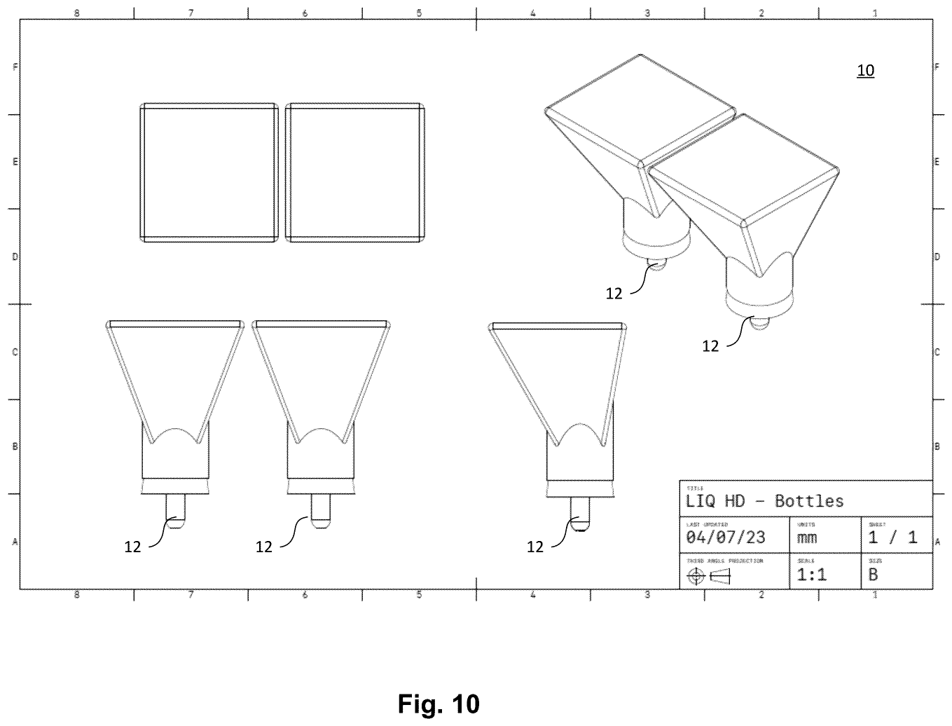

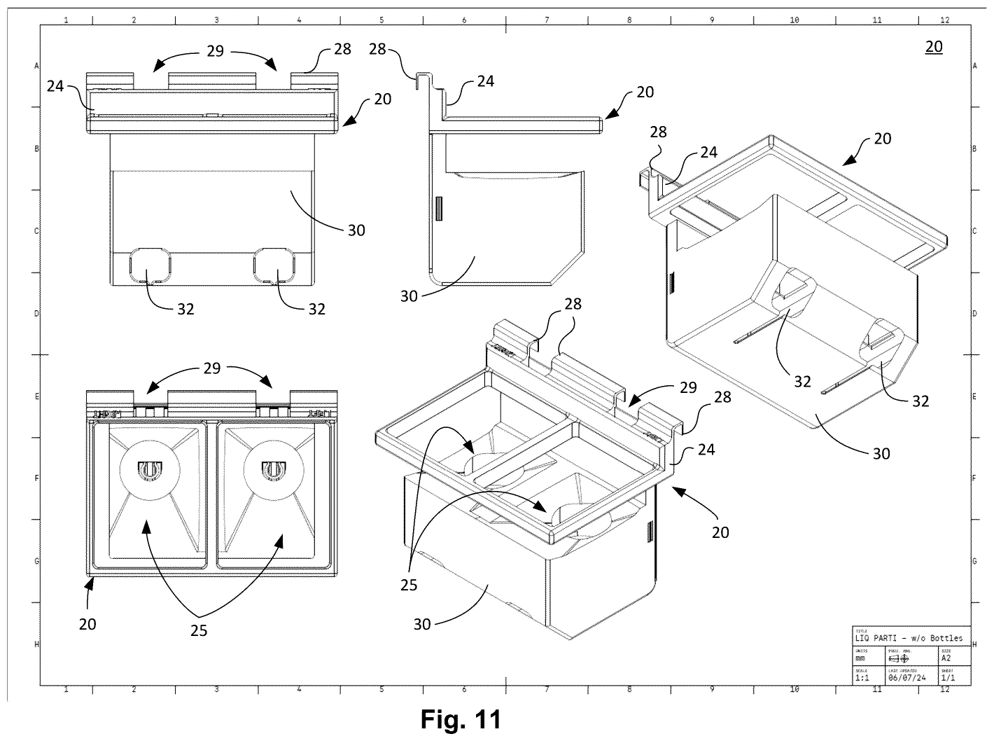

FIG. 10 shows one embodiment of bottles 10. The bottles 10 have inverted pyramidal container bodies leading to a sipper portion at the bottom. The square profile of the pyramidal shaped container bodies provides an efficient shape for the cage space, allowing the bottles 10 to be placed side by side without sacrificing space. However, circular or other shapes of bottles 10 can be envisioned where bottle opening 25 has a complementary shape. The sipper 12 is made of conductive material, e.g., metal.

Although not shown, when the device 100 is used in the system, the conductive tape is connected to a capacitive sensor via wiring. In the embodiments shown in FIGS. 5-9, the wiring can be routed through the rectangular opening 23 in the leg into frame 20, exiting from wiring notch 29 out of the cage to the capacitive sensor.

### Example 3

In another embodiment, the system (referred to as “LIQ-PARTI”, or Lick Instance Quantifier with Poly-Animal RFID Tracking Integration) allows for group-housed animals with RFID tag implants. The device can include two RFID readers below the sippers to identify which mouse is drinking from which bottle. The LIQ-PARTI can be better understood while referencing FIGS. 11-16.

Turning to FIG. 11, shown is an illustration of a frame 20 without the bottles 10 inserted. Similar to the example shown in FIG. 5, left and right denote the user view from outside the cage. The device 100 as shown in FIG. 11 includes two bottle orifices or openings 25 that are disposed within a housing 30. The housing 30 can comprise a plastic, metallic, wooden, or other material. The housing 30 can include one or more tunnels 32 which are configured to receive the head and neck of an animal subject. The housing 30 can include the bottle openings 25 for each bottle 10. The sipper portion of each bottle 10 can fit within the corresponding tunnel 32 of the housing 30. A sipper clip 26 is mounted within the housing 30 to receive the sipper portion 12 of each bottle 10. The frame 20 can include a top portion 24 equipped with a pair of hangers 28. Bottle openings 25 within the frame 20 receive the bottles 10. A wiring notch 29 is located between hangers 28.

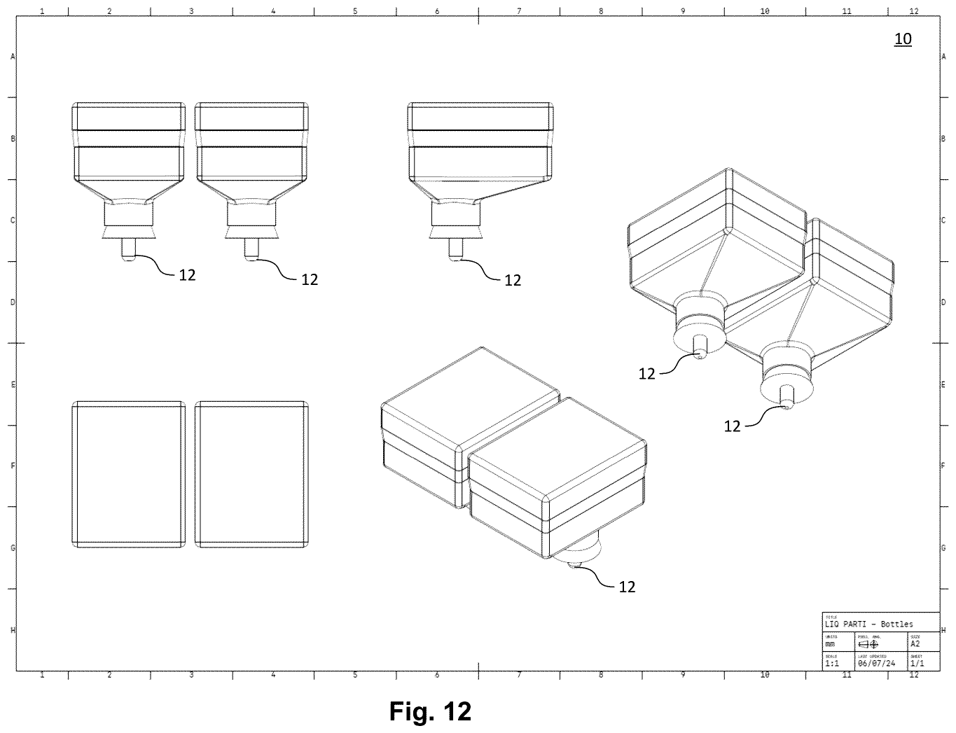

Next, at FIG. 12, shown is an illustration of the bottles 10. The bottles 10 have inverted pyramidal container bodies leading to a sipper portion at the bottom. The square profile of the pyramidal shaped container bodies provides an efficient shape for the cage space, allowing the bottles 10 to be placed side by side without sacrificing space. However, circular or other shapes of bottles 10 can be envisioned where bottle opening 25 has a complementary shape. The sipper 12 is made of conductive material, e.g., metal.

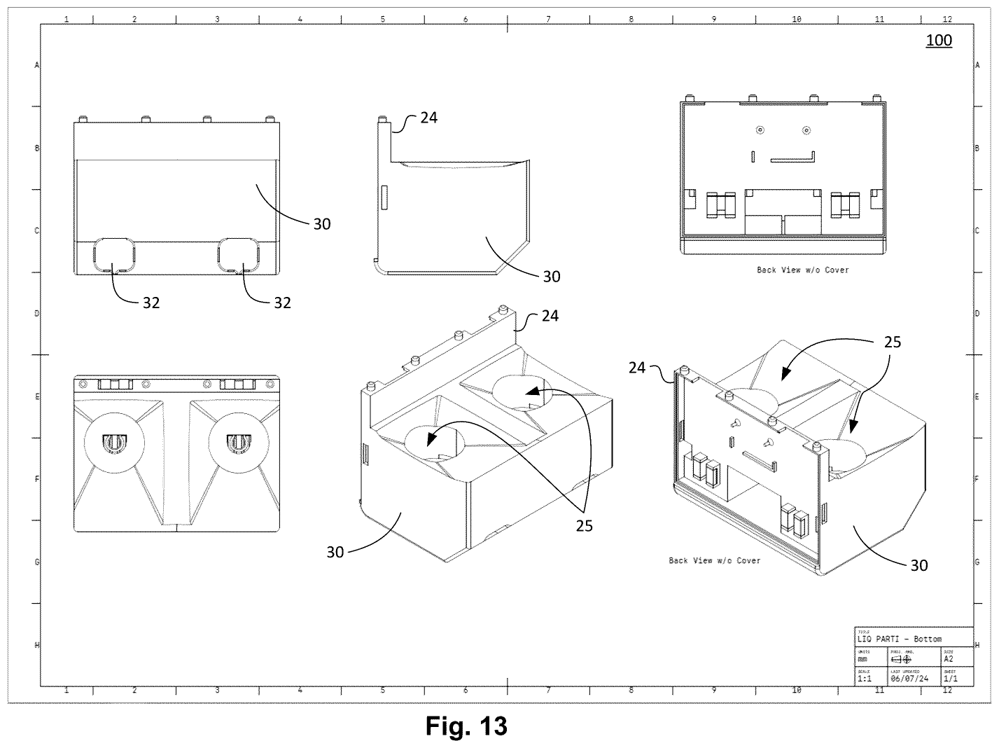

FIG. 13 shows an illustration of the bottom of the device 100.

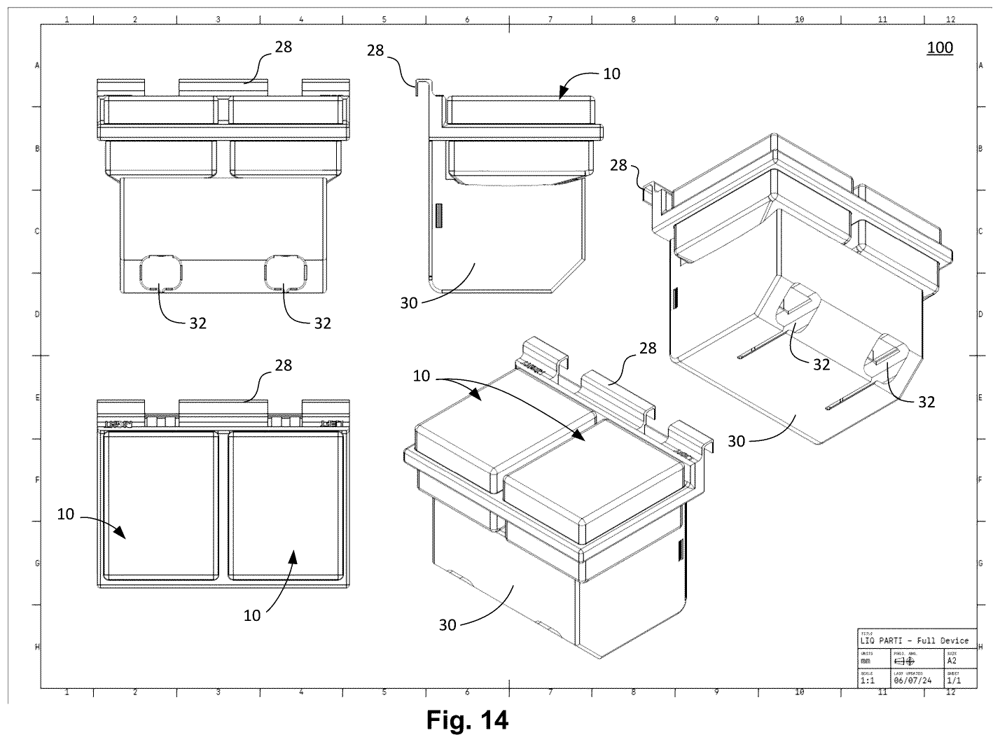

FIG. 14, shown is an illustration of the device 100 with the bottles 10 inserted.

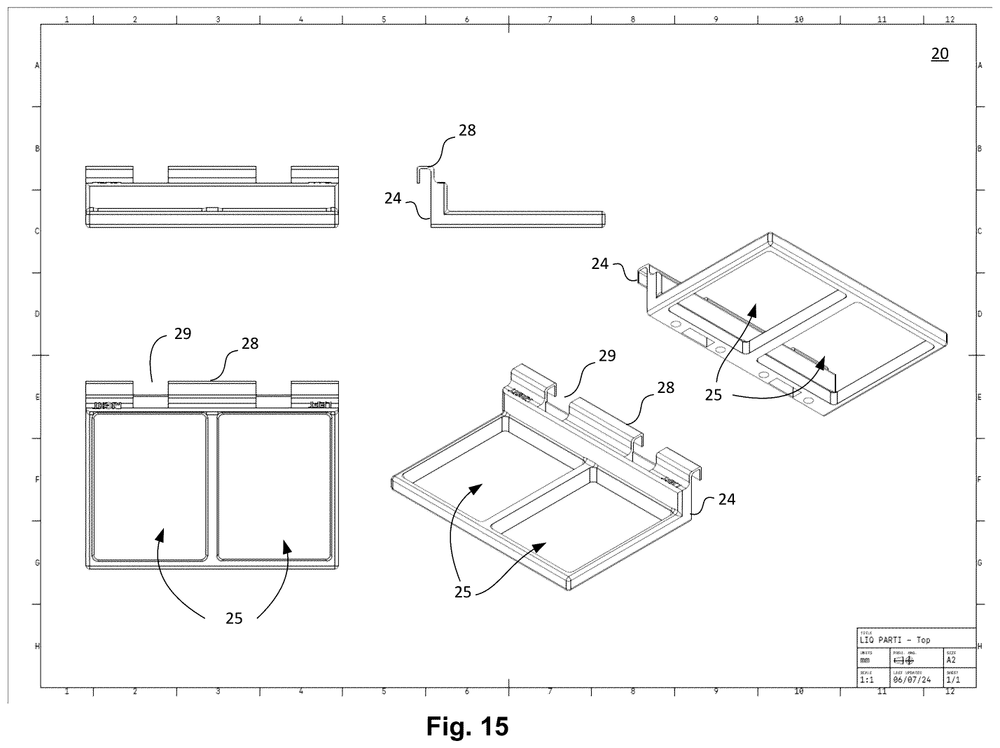

FIG. 15 shows an illustration of the top of the frame 20 of the device 100 inserted.

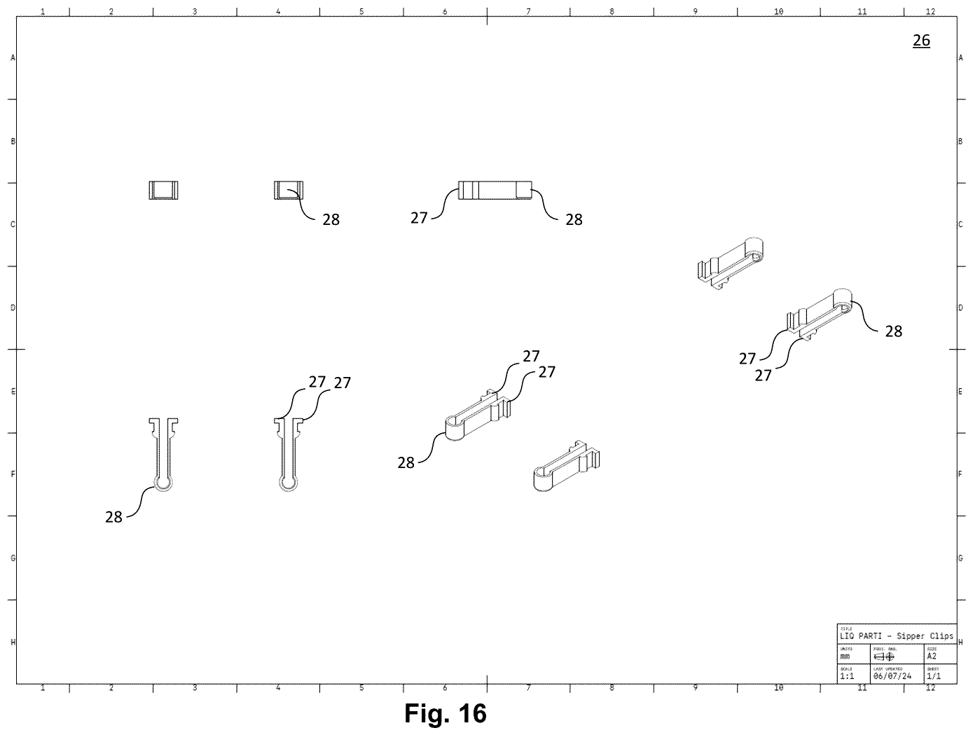

FIG. 16 shows an illustration of sipper clips in accordance with various embodiments of the present disclosure.

Although embodiments have been described herein in detail, the descriptions are by way of example. The features of the embodiments described herein are representative and, in alternative embodiments, certain features and elements may be added or omitted. Additionally, modifications to aspects of the embodiments described herein may be made by those skilled in the art without departing from the spirit and scope of the present invention defined in the following claims, the scope of which are to be accorded the broadest interpretation so as to encompass modifications and equivalent structures.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

It should be noted that measurements, amounts, and other numerical data can be expressed herein in a range format. It is also understood that there are a number of values disclosed herein, and that each value is also herein disclosed as “approximately” that particular value in addition to the value itself. For example, if the value “10” is disclosed, then “approximately 10” is also disclosed. Similarly, when values are expressed as approximations, by use of the antecedent “approximately,” it will be understood that the particular value forms a further aspect. For example, if the value “approximately 10” is disclosed, then “10” is also disclosed.

As used herein, the terms “about,” “approximately,” “at or about,” and “substantially equal” can mean that the amount or value in question can be the exact value or a value that provides equivalent results or effects as recited in the claims or taught herein. That is, it is understood that amounts, sizes, measurements, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In general, an amount, size, measurement, parameter or other quantity or characteristic is “about,” “approximate,” “at or about,” or “substantially equal” whether or not expressly stated to be such. It is understood that where “about,” “approximately,” “at or about,” or “substantially equal” is used before a quantitative value, the parameter also includes the specific quantitative value itself, unless specifically stated otherwise.

Where a range is expressed, a further aspect includes from the one particular value and/or to the other particular value. Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

What is claimed is:

1. A lick detection device comprising:
a frame comprising at least one bottle orifice and a hanger;
a sipper clip connected to the frame by a leg; and
a conductive strip on an interior surface of the sipper clip.

2. The lick detection device according to claim 1, further comprising at least one bottle inserted in the at least one bottle orifice, wherein the bottle comprises a sipper that mates with the interior of the sipper clip such that only an inferior surface of the sipper is exposed and wherein the sipper is in contact with the conductive strip.

3. The lick detection device according to claim 1, wherein the conductive strip is copper tape.

4. The lick detection device according to claim 2, wherein the bottle is pyramidally shaped.

5. The lick detection device according to claim 2, wherein the bottle has a capacity of about 90 mL.

6. The lick detection device according to claim 1, wherein the leg comprises a wiring orifice that connects to a wiring notch on the frame such that wires connected to the conductive strip exit the device from the wiring notch.

7. A lick detection system comprising:
a lick detection device according to claim 1, wherein the conductive strip is wired to a capacitive sensor and the capacitive sensor is in communication with a microcontroller;
a data logger in communication with the microcontroller;
a user device in communication with the microcontroller; and
a power source.

8. The system according to claim 7, wherein the user device is a touchscreen.

9. The system according to claim 7, wherein the microcontroller wirelessly communicates with the user device.

10. The system according to claim 7, further comprising a removable memory.

11. The system according to claim 10, wherein the removable memory is an SD card.

12. The system according to claim 7, further comprising a data logger shield.

13. The system according to claim 7, wherein the capacitive sensor is a multichannel sensor in communication with a plurality of sipper bottles.

14. The system according to claim 7, wherein the device comprises an interior wiring orifice for receiving wiring from the conductive strip and the capacitive sensor such that wiring to the microcontroller is not accessible to animals.

15. The system according to claim 7, wherein the data logger is configured to communicate data wirelessly to a wireless data storage.

16. A lick detection device comprising:
a frame comprising at least one bottle orifice and a hanger;
a housing disposed beneath the at least one bottle orifice, the housing comprising at least one sensor directed toward the at least one bottle orifice;
a sipper clip connected to the frame by a leg;
a conductive strip on an interior surface of the sipper clip.

17. The lick detection device of claim 16, wherein the at least one sensor comprises a radiofrequency identification (RFID) sensor.

18. The lick detection device according to claim 16, further comprising at least one bottle inserted in the at least one bottle orifice, wherein the bottle comprises a sipper that mates with the interior of the sipper clip such that only an inferior surface of the sipper is exposed and wherein the sipper is in contact with the conductive strip.

19. The lick detection device according to claim 16, wherein the conductive strip is copper tape.

20. The lick detection device according to claim 16, wherein the leg comprises a wiring orifice that connects to a wiring notch on the frame such that wires connected to the conductive strip exit the device from the wiring notch.
